(19) United States
(12) Patent Application Publication
(10) Pub. No.: US 2025/0371534 A1
(43) Pub. Date: Dec. 4, 2025

(54) VEHICLE CONTROL SYSTEM, VEHICLE CONTROL METHOD, AND STORAGE MEDIUM THEREOF

(71) Applicant: DENSO CORPORATION, Kariya-city (JP)

(72) Inventors: Koichi TAKAGI, Kariya-city (JP); Toshiaki HORAI, Kariya-city (JP); Shiori MANEYAMA, Kariya-city (JP)

(21) Appl. No.: 19/304,088

(22) Filed: Aug. 19, 2025

Related U.S. Application Data
(63) Continuation of application No. PCT/JP2024/005293, filed on Feb. 15, 2024.

(30) Foreign Application Priority Data
Mar. 8, 2023 (JP) 2023-035647
Jan. 18, 2024 (JP) 2024-006123

(51) Int. Cl. G06Q 20/40; G06F 9/451; G06Q 20/42

(52) U.S. Cl. CPC G06Q 20/40; G06F 9/452; G06Q 20/42

(57) ABSTRACT

A vehicle control system is configured to: communicate with a server via a network, the server storing information about a fee-based function that can be executed by an occupant of the vehicle; authenticate whether the fee-based function can be executed by performing a communication with the server; in response to an authentication of the fee-based function being succeeded, enable an execution of the fee-based function; in response to the authentication of the fee-based function being failed, determine whether the occupant intends to pay for an additional charge for the fee-based function without using (i) information transmitted from the server in advance or (ii) information generated with a same method as a generation method of information in the server; and in response to determining that the occupant intends to pay for the additional charge for the fee-based function, enable the execution of the fee-based function.

### CROSS REFERENCE TO RELATED APPLICATIONS

The present application is a continuation application of International Patent Application No. PCT/JP2024/005293 filed on Feb. 15, 2024, which designated the U.S. and claims the benefits of priority from Japanese Patent Application No. 2023-035647 filed on Mar. 8, 2023, and Japanese Patent Application No. 2024-006123 filed on Jan. 18, 2024. The entire disclosures of all of the above applications are incorporated herein by reference.

### TECHNICAL FIELD

The present disclosure relates to a vehicle control system, a vehicle control method, and storage medium storing vehicle control program.

### BACKGROUND

Conventionally, a vehicle is equipped with various vehicle devices, for example, vehicle audio devices, and the vehicle may receive a subscription service that can be used by the vehicle devices.

### SUMMARY

According to an aspect of the present disclosure, a vehicle control system equipped to a vehicle includes at least one of (i) a circuit and (ii) a processor with a memory storing computer program code executable by the processor, the at least one of the circuit and the processor configured to cause the vehicle control system to: communicate with a server via a network, the server storing information about a fee-based function that can be executed by an occupant of the vehicle; authenticate whether the fee-based function can be executed by performing a communication with the server; in response to an authentication of the fee-based function being succeeded, enable an execution of the fee-based function; in response to the authentication of the fee-based function being failed, determine whether the occupant intends to pay for an additional charge for the fee-based function without using (i) information transmitted from the server in advance or (ii) information generated with a same method as a generation method of information in the server; and in response to determining that the occupant intends to pay for the additional charge for the fee-based function, enable the execution of the fee-based function.

### BRIEF DESCRIPTION OF DRAWINGS

The present disclosure will become apparent from the following detailed description made with reference to the accompanying drawings. In the drawings:

FIG. 1A is a block diagram showing a configuration of a vehicle authentication system according to a first embodiment of the present disclosure;

FIG. 1B is a flowchart showing a process;

FIG. 2 is a flowchart showing a process;

FIG. 3 is a flowchart showing a process;

FIG. 4 is a flowchart showing a process;

FIG. 5 is a flowchart showing a process;

FIG. 6A is a flowchart showing a process;

FIG. 6B is a flowchart showing a process;

FIG. 7A is a flowchart showing a process;

FIG. 7B is a flowchart showing a process;

FIG. 8 is a block diagram showing a configuration of a vehicle authentication system according to a second embodiment of the present disclosure;

FIG. 9 is a flowchart showing a process;

FIG. 10A is a flowchart showing a process;

FIG. 10B is a flowchart showing a process;

FIG. 10C is a flowchart showing a process;

FIG. 11A is a flowchart showing a process according to a third embodiment of the present disclosure;

FIG. 11B is a flowchart showing a process;

FIG. 11C is a diagram showing an example of display screen;

FIG. 11D is a flowchart showing a process;

FIG. 11E is a diagram showing an example of display screen;

FIG. 11F is a diagram showing an example of display screen;

FIG. 12 is a flowchart showing a process;

FIG. 13A is a flowchart showing a process; and

FIG. 13B is a flowchart showing a process.

### DETAILED DESCRIPTION

The above-described subscription service used in a vehicle is a fee-based service. Thus, subscription service is provided on the basis of a contract which is defined in advance. When using the subscription service, authentication is required to determine whether a contract is made or not for the service. According to a related art, a function for authenticating a mobile object is provided.

The function according to related art is an alternative authentication method that requires a connection to a network. When a mobile object is traveling, the mobile object may travel through places where radio waves are difficult to reach, such as tunnels or deep in the mountains. Therefore, even if the mobile object's onboard equipment is performing communication, there is a possibility that a network connection failure will occur, and the vehicle-mounted device will go offline. When an authentication cannot be executed in an offline environment, it may cause anxiety to an occupant or cause problems for traveling.

According to an aspect of the present disclosure, a vehicle control system equipped to a vehicle includes a network communication unit, an authentication unit, and a control nit. The network communication unit is configured to communicate with a server via a network, the server storing information about a fee-based function that can be executed by an occupant of the vehicle. The authentication unit is configured to authenticate whether the fee-based function can be executed by performing a communication with the server. In response to an authentication of the fee-based function being succeeded, the control unit enables an execution of the fee-based function. In response to the authentication of the fee-based function being failed, the control unit determines whether the occupant intends to pay for an additional charge for the fee-based function without using (i) information transmitted from the server in advance or (ii) information generated with a same method as a generation method of information in the server. In response to determining that the occupant intends to pay for the additional charge for the fee-based function, the control unit enable the execution of the fee-based function. This configuration can improve user convince.

The following will describe several embodiments of a vehicle authentication system and a vehicle control system with reference to the drawings. In each embodiment to be described below, the same or similar reference symbols are used to designate the same or equivalent configurations, and a description thereof will be omitted as necessary.

### First Embodiment

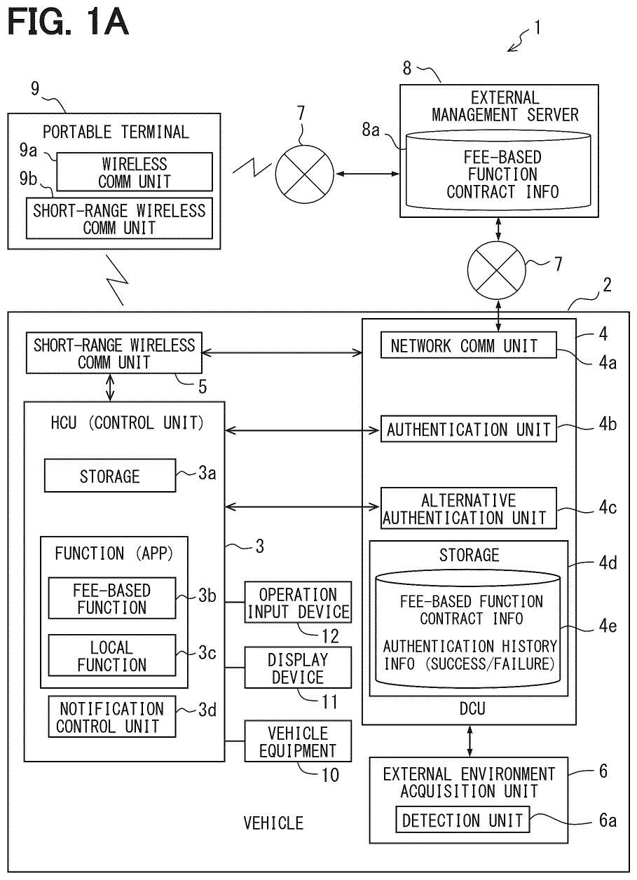

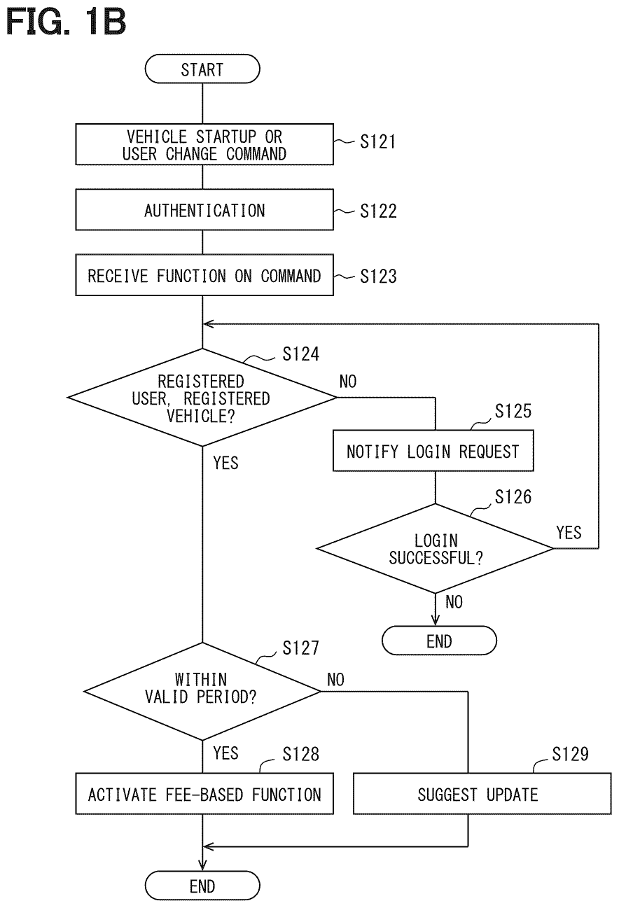

The following will describe a first embodiment with reference to FIG. 1A to FIG. 7B. A vehicle system 1 shown in FIG. 1A includes an HCU 3, a DCU 4, and other ECUs (not shown), which are installed inside a vehicle 2 and connected via a network. The vehicle system 1 further includes an external management server 8 located outside the vehicle 2. The external management server is also referred to as a server. A user may carry a portable terminal 9 such as a smartphone, tablet, or laptop computer in or near the vehicle 2, and the portable terminal 9 also constitutes the vehicle system 1. The vehicle system 1 is used as a vehicle authentication system and a vehicle control system.

The HCU 3, the DCU 4, the external management server 8, and the portable terminal 9 are communicatively connectable via a network 7, thereby constituting the vehicle system 1. HCU is an abbreviation for human machine interface control unit. DCU is an abbreviation for domain control unit. The network 7 may be a wired communication network or a wireless communication network.

### (HCU 3)

The HCU 3 constitutes a display system ECU. ECU is an abbreviation for electronics control unit, which is also known as an electronic control device. The HCU 3 includes a processor, a storage 3a, an I/O, and a bus connecting these components. The HCU 3 functions as a controller that performs various types of controls by executing programs stored in the storage 3a. The storage 3a is a non-transitory tangible storage medium that stores, in non-transitory manner, computer-readable programs and data. The non-transitory tangible storage medium may be implemented by a semiconductor memory or the like. The HCU 3 is connected to a short-range wireless communication unit 5, and the HCU is able to perform communication with the portable terminal 9 via the short-range wireless communication unit 5 and a short-range wireless communication unit 9b of the portable terminal 9.

The HCU 3 executes application programs (hereinafter, referred to applications) stored in the storage 3a to implement various functions, such as a fee-based function 3b, a local function 3c, and a notification control unit 3d. The HCU 3 is connected to a display device 11. The display device 11 includes a liquid crystal display or an organic EL display, etc., and is configured to display content in monochrome or full graphics. The display device 11 is provided as a center information display. The HCU 3 is connected to an operation input device 12. The operation input device 12 is implemented by a touch panel arranged on a surface of the display device 11, or is implemented by mechanical switches arranged close to the display device 11. The operation input device 12 receives operation inputs from a user and outputs operation signals to the HCU 3. The HCU 3 is capable of executing various functions based on operation signals from the operation input device 12. The HCU 3 or the DCU 4 is connected to a vehicle device 10.

The application functions implemented by the HCU 3 may be classified into the fee-based function 3b and the local function 3c. The fee-based function 3b indicates a function that is executed based on contract information of fee-based function approved by the user of vehicle 2. When the HCU 3 confirms a matching of the contract information of fee-based function of the vehicle device 10, the HCU 3 serves as an execution unit that executes the fee-based function 3b under the contract. The local function 3c indicates a function that is executed by an application pre-installed in the storage 3a without charge, and indicates a function that can be executed without approving a contract for the above-described fee-based function.

### (DCU 4)

The DCU 4 is a centralized cockpit electronic system built on a platform in which software and hardware are integrated. The DCU 4 includes a storage 4d in which a database 4e is built. DCU4 is abbreviation for domain control unit.

The DCU 4 is connected to an external environment acquisition unit 6. The external environment acquisition unit 6 acquires information about an external environment of the vehicle 2. The external environment acquisition unit 6 includes a detection unit 6a. The detection unit 6 a is implemented by a sensor for acquiring external environment information of the vehicle 2. For example, examples of the sensor may include a temperature sensor that detects an outside air temperature of the vehicle 2, an illuminance sensor that detects a sunlight illuminance outside the vehicle 2, a front view camera, a side view camera, a corner view camera, a rear view camera, an electronic mirror, a laser radar implemented by LiDAR, and a peripheral monitoring sensor that monitors a periphery area around the vehicle 2 using millimeter wave radar.

The detection unit 6a may further detect a user state by using an occupant monitor. The occupant monitor detects a state of on-board occupant in the vehicle 2 or an operation state of various operating devices by the occupant. The occupant monitor includes a camera, and the camera detects the state of occupant in the driver seat, front occupant seat or rear seat by capturing an image of the occupant using an image sensor and then outputs an image capture signal. The occupant state monitor for monitoring the driver is referred to as DSM. DSM is an abbreviation for driver status monitor. The DCU 4 functions as an individual recognition unit that identifies a user who is in the vehicle 2 based on the detection result of the occupant monitor.

The DCU 4 is communicatively connected to the HCU 3 and other devices such as ECUs (not shown), and can transmit and receive various information to and from each other. The electronic control devices, including the DCU 4, HCU 3 and other devices, implement functions such as a driving control unit that is responsible for driving control of the vehicle 2, a periphery monitoring unit that monitors the periphery of the vehicle 2, and a display unit that presents information to the user via the display device 11.

The driving control unit controls driving of vehicle through manual or automatic driving using a gasoline engine, diesel engine, electric motor, etc. The driving control unit implements a manual driving control mode in which manual driving is performed. The driving control unit implements an automatic driving mode in which automated driving is performed according to various levels of automated driving. In the automated driving mode, a cruise control ECU of automated driving controls a driving actuator to perform a corresponding predetermined level of driving assistance and automated driving.

For example, the driving assistance of level I includes an automated braking operation to avoid collisions with obstacles, a follow-up driving operation to follow a preceding vehicle, or a lane departure prevention driving operation that controls the vehicle to not depart from the traveling lane marks on both sides. The automated driving of level II can execute the driving assistance of level I, and can further execute an automated driving mode that controls the vehicle to perform automated driving under specific conditions. For example, under level II, the automated driving can control the vehicle 2 to automatically pass over a slow vehicle on an expressway, or control the vehicle 2 to automatically merge onto or come out the road at a branch point in the expressway. The driver is required to monitor the automated driving in level II. In automated driving at level III or higher, the driving control system performs all driving tasks by monitoring a periphery of the vehicle using the periphery monitoring system equipped to the vehicle 2. Detailed explanation is omitted. This driving control can be performed in manual driving mode and automated driving mode.

The DCU 4 is configured to be connectable to a network 7 outside the vehicle via a network communication unit 4a. The network communication unit 4a functions as a block that performs a communication between internal and external device of the vehicle 2. The network communication unit 4a communicates via the network 7 with an external management server 8 that stores information on fee-based function that can be executed by a user who is an occupant of the vehicle 2.

The DCU 4 executes the application stored in the storage 4d to provide various functions, for example, the functions of an authentication unit 4b and an alternative authentication unit 4c, which will be described later. The storage 4d is a non-transitory tangible storage medium that non-transiently stores computer-readable programs and data. The non-transitory tangible storage medium may be implemented by a semiconductor memory or the like.

The storage 4d stores a database 4e. The database 4e is used as an authentication history information storage that stores authentication history information indicating the authentication result (success/failure) determined by the authentication unit 4b together with the date and time of authentication. The database 4e also stores and holds contract information of fee-based function.

The authentication unit 4b authenticates whether a fee-based function can be executed via the network communication unit 4a. The alternative authentication unit 4c can substitute the authentication unit 4b and execute the authentication when the authentication unit fail to connect to the external management server 8 via the network communication unit 4a.

### (Portable Terminal 9 and Contract of Fee-Based Function)

A user aboard the vehicle 2 carries a portable terminal 9. The portable terminal 9 is a terminal that can be brought into the vehicle compartment. The portable terminal 9 includes an interface for inputting operations, such as a display or the like. The portable terminal 9 is capable of receiving various operation inputs, and is capable of performing notification processes.

The portable terminal 9 includes a processor, a memory, and an I/O (not shown). The portable terminal 9 is equipped with a wireless communication unit 9a for wirelessly communicating with the external management server 8 via the network 7. The portable terminal 9 is equipped with a short-range wireless communication unit 9b that performs short-range communication with the short-range wireless communication unit 5 of the vehicle 2 using a wireless LAN, such as WiFi (registered trademark) or a short-range communication technology, such as Bluetooth (registered trademark).

An application for vehicle 2 is installed in the memory of the portable terminal 9, and by executing the vehicle application on the portable terminal 9, the user can issue control commands related to the vehicle 2 and obtain information about the vehicle 2 from the HCU 3 or DCU 4, which are equipped to the vehicle 2. At this time, the user can operate the portable terminal 9 to set the setting information related to the vehicle device 10. The vehicle device 10 here may be an air conditioner, a vehicle audio visual device, but is not limited to these examples.

The user operates the operation input device 12 or the portable terminal 9 to purchase or rent a subscription service related to the vehicle device 10. In the following, subscription service will be abbreviated as “subscription.” The user inputs, using the operation input device 12 or the portable terminal 9, predetermined identification information as a new ID into a form provided by a management provider of predetermined external management server 8 via the network 7. Then, by accepting the terms of contract, the user enters into a purchase contract or rental contract for the subscription service with the subscription provider using the new legitimate ID. Such subscription services may be time-limited with expiration date or lifetime subscription.

The contract information for the fee-based function related to the subscription service is registered in the database 8a of the external management server 8 in association with the user. The external management server 8 stores contract information for the fee-based functions in the database 8a. The contract information for the fee-based function is also registered in a database 4e of the DCU 4.

The contract information for the fee-based function is information that indicates the purchase status of subscription service for each user of the vehicle 2, such as an individual, a corporation, or an organization. The contract information for fee-based functions includes purchase information for various functions purchased by the user or rental information for various functions rented by the user, user identification information, charging information for a certain period of time or per use, and expiration date information indicating the period for which the subscription service is provided. The database 8a stores multiple pieces of contract information for fee-based function for respective users, linked to, for example, names and user identification numbers of the respective users.

The subscription service for the fee-based function includes a music distribution subscription service for vehicle audio equipment and a video distribution subscription service that allows video to be displayed on the display device 11 of the vehicle. Other examples of subscription service may include services related to comfort features, such as seat heater to improve user experience in the vehicle compartment, and drive mode subscription service that enable a change in the performance of the manual driving or automated driving of the vehicle 2. Other examples of subscription service may include services related to driving assistance in automated driving mode or functions at each level of automated driving, and subscription services related to lighting up the compartment of vehicle 2.

The following will describe an internal processing of the vehicle 2 after the power of vehicle is turned on.

(A Case where the Connection with the External Management Server 8 is in Good Condition)

When the driver turns on the vehicle power switch via an ignition switch or a power button, power is supplied to the HCU 3, the DCU 4, and the like. The network communication unit 4a of the DCU 4 establishes a connection with the external management server 8 through the network 7 and establishes a session with the external management server 8. As long as the network communication unit 4a of the DCU 4 is not disconnected from the external management server 8, the DCU 4 determines that the communication condition through the network 7 is good. At this time, the network communication unit 4 is capable of communicating with the external management server 8.

The DCU 4 performs, using the authentication unit 4b, authentication by comparing the contract information for the fee-based function stored in the database 4e with the contract information for the fee-based function stored in the database 8a of the external management server 8.

The DCU 4 performs communication processing between the network communication unit 4a and the external management server 8 via the network 7. When the authentication unit 4b success in authentication for execution of the fee-based function as a result of the communication processing, authentication history information indicating that the authentication is succeeded is stored in the database 4e. When the DCU 4 determines that the fee-based function can be executed, the DCU 4 updates, as necessary, the confirmation date and the like of the contract information of the fee-based function, which is determined to be executable, in the database 4e.

As a result, the contract information for the fee-based function stored in the database 8a by the external management server 8 and the contract information for the fee-based function stored in the database 4e of the DCU 4 inside the vehicle 2 are updated as necessary. The contract information for the fee-based function is updated periodically, for example, every few days or once a month.

The following will describe an authentication operation executed by the authentication unit 4b to determine whether the fee-based function can be executed with reference to FIG. 1B. When the vehicle 2 is started in S121, the DCU 4 performs online authentication by the authentication unit 4b in S122. When a command to change the occupant of the vehicle 2 is detected, the authentication unit 4b performs the online authentication in response to receiving a turn-on command to turn on the function in S122.

The online authentication in the external management server 8 requires login information. In S124, when the login information of the occupant or user has already been registered in the database 4e of the DCU 4, or when the identification information of the vehicle 2 has already been registered as login information in the database 4e of the DCU 4, the process proceeds to S127.

In S124, in response to determining that the occupant or user is not a registered occupant or the identification number is not a registered vehicle 2, the DCU 4 issues a login request to the occupant of the vehicle 2 in S125. As a result of being notified of the login request, the occupant attempts to log in. The method of authenticating the ID of the occupant may include authentication of the identification information of the vehicle 2 (such as the vehicle identification number), personal authentication using the occupant monitor of the detection unit 6a described above, and authentication by inputting an individual password. When the occupant has successfully logged in, the process returns to S124, and the determination result in S124 becomes YES.

The DCU 4 refers to the database 4e for the contract information of fee-based function of the logged-in occupant, and determines in S127 whether the fee-based function is within the expiration date. When the fee-based function is in effective state within the expiration date, the DCU 4 activates the fee-based function in S128. When the fee-based function is not within the expiration date, a notification is output in S129 to suggest renewal of the contract for the fee-based function. For example, message such as “Your subscription has been expired on month X date Y. Would you like to update service?” may be output to the user to encourage the user to update the service. When the renewal is approved, the DCU 4 communicates with the external management server 8, updates the contract information stored in the database 4e or 8a, and extends the expiration date.

In S124, at a determination timing when the information is determined to be not registered in the database 4e of the DCU 4, the DCU 4 may perform communication with the external management server 8, and the external management server 8 may update the contract information for the fee-based function registered in the database 8a of the external management server 8 based on comparing result.

(A Case where the Vehicle 2 Fails to Connect to the External Management Server 8 During Traveling State)

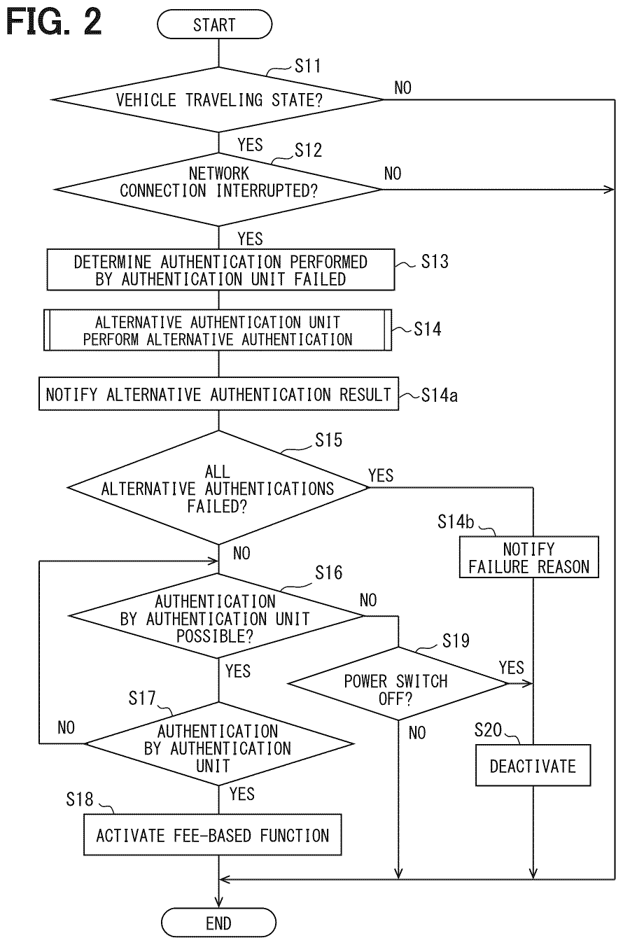

The following will describe a processing operation while the vehicle 2 is traveling with reference to FIG. 2 to FIG. 6B. In S11 of FIG. 2, when the vehicle 2 is determined to be in a traveling state on a road, the network communication unit 4a periodically determines whether the communication connection with the external management server 8 via the network 7 can be continued in S12.

When the network communication unit 4a performs communication processing with the external vehicle management server 8 via the network 7 and determines that the network connection is interrupted due to reasons such as a weak radio reception environment, the authentication unit 4b fails to authenticate whether the fee-based function can be executed in S13 and determines that the authentication is failed. In this case, the DCU 4 stores authentication history information indicating that the authentication has failed in the database 4e.

When the connection to the network 7 is cut off and the authentication unit 4b fails to determine whether the fee-based function can be executed via the network communication unit 4a, the DCU 4 performs alternative authentication (the function of alternative authentication unit 4c) in S14. The DCU 4 performs the alternative authentication based on information stored in a storage 4d or a storage 3a included in the vehicle 2 (corresponding to the function of alternative authentication unit 4c). The DCU 4 determines whether the fee-based function can be executed in response to a result of the alternative authentication. Then, the notification control unit 3d may notify, in S14a, the occupant of the result of the determination made by the alternative authentication unit 4c as to whether or not the fee-based function can be executed. Thus, the occupant can understand the result of alternative authentication.

When the DCU 4 suddenly stops use of the fee-based function when the authentication by the authentication unit 4b fails, the driver of the vehicle may be surprised and may adversely affect the driving operation performed by the driver. To solve this problem, when the fee-based function is related to the safety and security of the occupant, continued use of the fee-based function may be permitted without any condition (corresponding to the function of alternative authentication unit 4c). When the DCU 4 is using the fee-based function at the time when the providing of fee-based function is determined to be stopped due to the authentication failure determined by the authentication unit 4b, continued use of the fee-based function may be permitted without any condition without making the determination to stop use of the fee-based function (corresponding to the function of alternative authentication unit 4c).

The DCU 4 may determine that the fee-based function can be executed and perform the alternative authentication when the fee-based function is at least one of the following categories: a function required for traveling of vehicle 2, a function necessary for the safety of the user (occupant), or a function for making the internal environment of the vehicle 2 comfortable (corresponding to the function of alternative authentication unit 4c). When the fee-based function corresponds to two or more of the above-described categories, the fee-based function may be determined to be executable.

### (Function Required for Traveling of Vehicle 2)

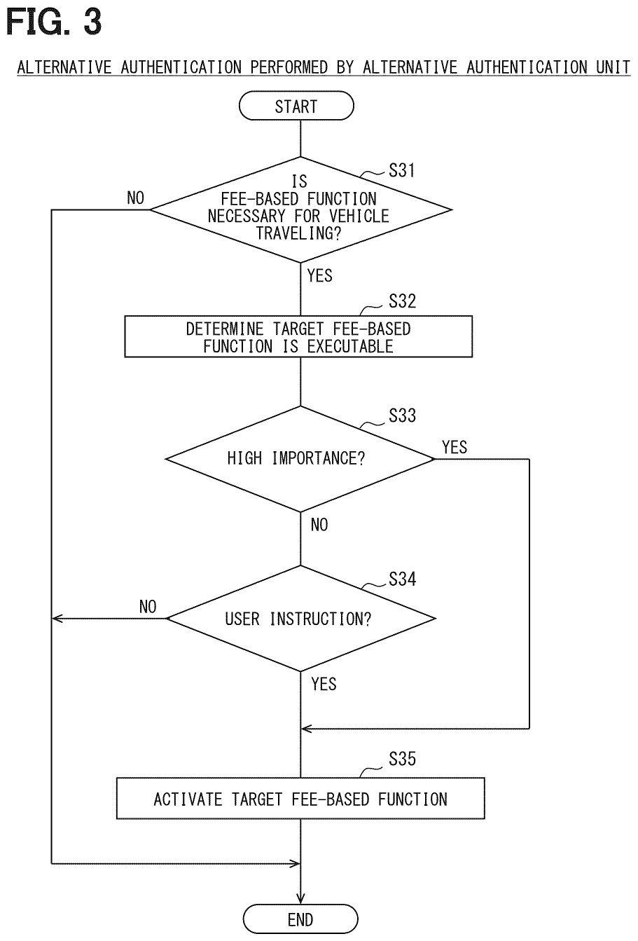

As shown in FIG. 3, the DCU 4 determines in S31 whether the fee-based function for which execution is determined is a function necessary for the vehicle 2 to travel. In response to determining that the fee-based function is required for traveling of the vehicle, the DCU4 performs processing of S32 and subsequent steps using the function of alternative authentication unit 4c.

For example, when a user drives the vehicle 2, the user sets a driving mode via the operation input device 12 in order to change the driving performance of the vehicle 2. When the driving mode is set, the driving control ECU sets a driving performance according to the driving mode, and controls the driving of vehicle 2. In this driving mode, the operation of manual driving performed by the user is assisted to enable driving control. A standard normal mode is preset to a mode that emphasizes the balance between operability and comfort.

A sport mode is preset to a mode in which the response characteristics of acceleration and deceleration are improved compared to the normal mode. A race driving mode is preset to provide even more active acceleration and deceleration response than the sport mode. A comfort mode is preset to emphasize comfortability.

A snow mode is preset to a mode that makes the driving performance of vehicle 2 suitable for driving on snowy roads. An eco mode is preset to a mode that provides improved fuel economy compared to the normal mode. When the user selects one of these driving modes as the fee-based function and purchases or rents the selected function, the user can select the driving mode by operating the operation input device 12.

These driving modes include functions required for traveling of the vehicle 2. For example, in the sport mode or the race driving mode, the HCU 3 presents, in visual manner, examples of gear shifting, accelerator work, and brake work on the display device 11, and provides a service that allows the user to operate the gear, accelerator, and brake in accordance with the displayed example. In the snow mode, a service is provided such that the driving performance of vehicle 2 is adjusted to a performance suitable for driving on the snowy roads.

Even when the DCU 4 fails to authenticate these driving modes as fee-based functions through the network communication unit 4a, in response to the DCU 4 determining in S31 that the function is required for traveling of the vehicle 2, the process determines in S32 that the target fee-based function can be executed.

The DCU 4 determines an importance of the target fee-based function in S33. This importance indicates the degree to which a function is required for traveling of the vehicle 2, and is preset in multiple increasing stages with the most necessary function to have the highest importance. The importance information is stored, in advance, in the storage 4d. For example, the snow mode is a function that is important for the vehicle 2 to travel safely on a snowy road. The race driving mode is a mode that is relatively focused on hobby and preference, and is therefore a function that is less important for the traveling of vehicle 2. Although an example of setting the importance is given here, the order of importance is not limited to the above-described example.

When the importance level is determined to be equal to or lower than a predetermined level in S33 (S33: NO), the DCU 4 can activate the target fee-based function in S35 and make the subscription service for the fee-based function available after obtaining a permission of user, which is input by an operation instruction made by the user in S34. When the DCU 4 determines that the importance of the target fee-based function is higher than the predetermined level in S33 (S33: YES), the DCU 4 can forcibly activate the target fee-based function in S35 without asking for an instruction from the user, thereby making the subscription service available to the user. This allows the user to use the corresponding fee-based function.

### (Function Required for Safety of User or Occupant)

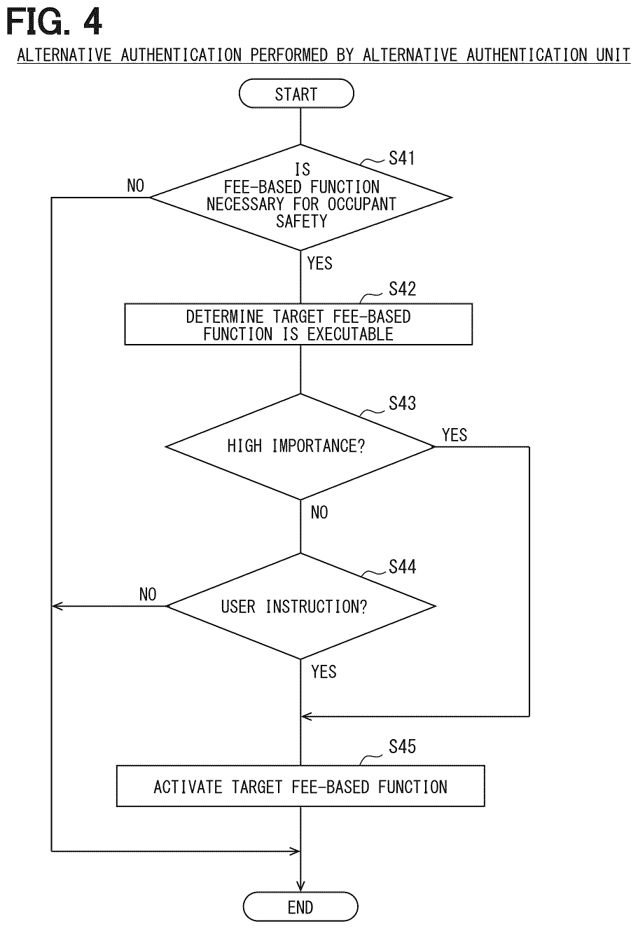

As shown in FIG. 4, when the DCU 4 determines in S41 whether a target fee-based function is a function required for the user's safety. In response to determining that the target fee-based function is the required function for the user safety, the alternative authentication unit 4c executes the process in S42 and subsequent step. The target fee-based function is a function for which whether execution of the corresponding function is determined.

For example, the vehicle 2 is provided with a manual driving mode and an automated driving mode. When a user drives the vehicle 2, the user changes the setting of driving mode of the vehicle 2 by performing an operation from the operation input device 12. When a driving mode is set, the driving control system ECU controls the driving of the vehicle 2 in accordance with the set driving mode.

In automated driving mode, the method of driving assistance or automated driving varies according to the automated driving level. When the user purchases or rents each level of the automated driving mode as the fee-based function, the user can select the driving mode by performing an operation on the operation input device 12. For example, functions such as a radar cruise control function (LCC), an emergency stop function for collision prevention, and an accelerator depression prevention function can be selectively executed.

When the DCU 4 fails to authenticate a driving mode as the fee-based function through the network communication unit 4a, in response to the DCU 4 determining, in S41 of FIG. 4, that the function is required for the safety of occupant, the DCU 4 determines in S42 that the target fee-based function can be executed.

Then, the DCU 4 determines the importance of target fee-based function in S43. The importance level indicates the requirement degree for the safety of occupant, and is preset in multiple increasing stages with the most necessary function to have the highest importance. The importance information is stored, in advance, in the storage 4d.

For example, the emergency stop function for preventing a collision is a necessary and important function for preventing a collision accident with another vehicle 2 or an obstacle, taking safety into consideration. For this reason, the importance of emergency stop function is set relatively high. From the safety perspective, the accelerator depression prevention function is an important function for preventing a collision accident with an obstacle, and therefore the importance of accelerator depression prevention function is set to be relatively high. The radar cruise control function is a function that allows the vehicle 2 to follow the preceding vehicle traveling in front of the vehicle 2 while maintaining a certain distance with the preceding vehicle. Thus, the importance of radar cruise control function is set to a relatively low importance compared to the emergency stop function and the accelerator depression prevention function. Although an example of setting the importance information has been described here, the order of importance is not limited to this example.

When the DCU 4 determines in S43 that the importance of target fee-based function is equal to or lower than a predetermined level, the DCU 4 obtains a permission of user through an operational instruction from the user in S44, and then activates the target fee-based function in S45. When the DCU 4 determines in S43 that the importance of target fee-based function is higher than the predetermined level, the DCU forcibly activates the target fee-based function in S45 without obtaining a permission of user through a user instruction. Thus, the user can use the corresponding fee-based function.

Whether the target fee-based function is a fee-based function related to safety and security and has a higher importance than the predetermined level may be stored in the external management server 8 or the storage 4d of the DCU 4. When the fee-based function is related to safety and security, the DCU 4 may activate the fee-based function using the alternative authentication unit 4c without any condition. As a result, when the DCU 4 fails to authenticate the license of fee-based function, in response to the fee-based function to be authenticated being determined as a function related to the safety and security of the occupant, the DCU 4 can execute the fee-based function without any condition.

### (Function for Making Internal Environment of Vehicle 2 Comfortable)

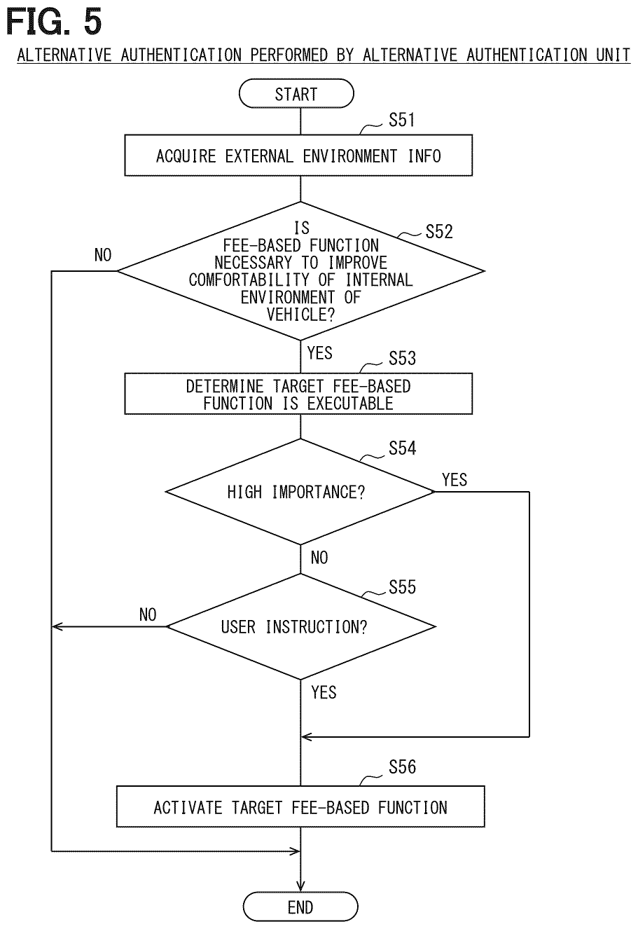

As shown in FIG. 5, in S52, the DCU 4 determines, by the alternative authentication unit 4c, whether the target fee-based function is a comfortability function for making the internal environment to be comfortable. The target fee-based function is the function for which execution of the function is determined. In S52, when the DCU 4 determines that the target fee-based function corresponds to the comfortability function, the DCU 4 determines in S53 that the target fee-based function can be executed.

When the DCU 4 determines, in S52, whether to execute the comfortability function to make the internal environment of the vehicle 2 comfortable, the DCU 4 may acquire external environmental information in S51 prior to S52, and perform alternative authentication by adding the external environmental information of the vehicle 2 to the condition for determination of whether to execute the fee-based function. For example, as the external environment information, outside air temperature information obtained by a temperature sensor or illuminance information obtained by an illuminance sensor may be used.

When the DCU 4 determines that the outside air temperature is lower than a predetermined standard temperature, the DCU determines that the heating function in the vehicle compartment can be performed using a vehicle equipment 10 for heating function, such as an air conditioning device or a seat heating device (corresponding to function of alternative authentication unit 4c). When the DCU 4 determines that the outside air temperature is equal to or higher than a predetermined standard temperature, the DCU 4 determines that the cooling function can be performed using a vehicle equipment 10 for cooling function, such as an air conditioner (corresponding to function of alternative authentication unit 4c).

The subscription service that lights up the compartment of vehicle 2 is classified as the category of comfortability function. The DCU 4 determines whether to execute the fee-based function by using illuminance information acquired by an illuminance sensor as environmental information outside the vehicle 2 (corresponding to the function of alternative authentication unit 4c). For example, when the DCU 4 determines that the illuminance outside the vehicle is lower than a predetermined value, the DCU 4 determines that it is possible to light up the vehicle compartment using lighting device, such as LED (corresponding to the function of alternative authentication unit 4c). When the DCU 4 determines that the illuminance outside the vehicle is equal to or higher than a predetermined value, the DCU 4 disables the lighting device (corresponding to function of alternative authentication unit 4c).

Other comfortability functions include music distribution services, video and movie distribution subscription services, or the like. When the DCU 4 fails to authenticate the fee-based function through the network communication unit 4a, in response to determining in S52 of FIG. 5 that the fee-based function corresponds to the comfortability function, the DCU 4 determines in S53 that the target fee-based function can be executed (corresponding to function of alternative authentication unit 4c).

The DCU 4 determines the importance of target fee-based function in S54. This importance indicates the requirement degree of comfortability to make the internal environment of vehicle 2 comfortable, and is preset in multiple increasing stages with the most necessary function to have the highest importance. The importance information is stored, in advance, in the storage 4d.

For example, among the comfortability functions, the cooling/heating function for the vehicle compartment is set to a relatively high importance. The function of lighting up the compartment of vehicle 2 is set to a relatively low importance.

Although an example of setting the importance is described here, the order of importance is not limited to the above-described example.

When the DCU 4 determines in S54 that the importance is equal to or lower than a predetermined level, the DCU 4 obtains a permission of user, through an operational instruction from the user, in S55, and then activates the target fee-based function in S56. When the DCU 4 determines that the importance of target fee-based function is higher than a predetermined level, the DCU 4 forcibly activates the target fee-based function in S56 without asking for the user instruction. Thus, the user can use the corresponding fee-based function.

The following will describe the subsequent process with reference to FIG. 2. The DCU 4 acquires, in S14, the result of alternative authentication performed by the alternative authentication unit 4c, and notifies the result of alternative authentication in S14a. For example, the DCU 4 may control the display device 11 to display, via the HCU 3, “Alternative authentication has succeeded (or failed)” (corresponding to first notification information). The DCU 4 may communicate with the portable terminal 9 and display the information on the display screen of the portable terminal 9. Then, the DCU 4 may display, on the display device 11 or the portable terminal 9, a message of “The function will continue. The period during which it can be used is until the vehicle is stopped and the engine is turned off” (corresponding to second notification information).

The first notification information and the second notification information may be transmitted and notified successively in time series, or may be transmitted and notified simultaneously. The DCU 4 may be configured to display a predetermined special icon representing the alternative function on the display device 11 or the portable terminal 9 only during the period in which use of the function is permitted by the alternative authentication unit 4c.

In S15, the DCU 4 determines whether authentications performed by the alternative authentication units 4c has failed. When all authentications performed by the alternative authentication unit 4c have failed, the DCU 4 disables the subscription service of the target fee-based function in S20. In the case where both the authentication by the authentication unit 4b and the authentication by the alternative authentication unit 4c of the DCU 4 fail, the HCU 3 may notify the user of the detailed reason for the authentication failure in S14b. For example, the DCU 4 may inform the user of the reason, such as “Authentication failed due to a network connection failure.” This allows the vehicle occupant to understand the reason why use of the function is disabled, and can avoid that the vehicle occupant feels distrust about the function. Although a network disconnection has been exemplified here, even though authentication fails due to a cause other than the disconnection of network 7, the detailed reason for failure may be notified to the user.

When the process determines in S15 that not all authentications by the alternative authentication unit 4c failed, the DCU 4 continues to enable the use of fee-based function after authentication by the alternative authentication unit 4c, as described above with reference to FIG. 3 to FIG. 5. After the authentication by the alternative authentication unit 4c is completed, the DCU 4 further determines in S16 whether authentication by the authentication unit 4b through the network 7 is possible. That is, the DCU 4 determines whether online authentication is possible.

When authentication by the authentication unit 4b becomes possible in S16, the authentication unit 4b authenticates use of the fee-based function in S17, and activates the fee-based function in S18 in response to the authentication in S17 successes. The determination result by the alternative authentication unit 4c as to whether to execute the fee-based function remains valid until authentication by the authentication unit 4b becomes possible. This is because, once confirmation is made by the authentication unit 4b, alternative authentication by the alternative authentication unit 4c becomes unnecessary. When the DCU 4 is unable to perform authentication by the authentication unit 4b in S17, it returns to S16 and continues to wait until authentication becomes possible. That is, the DCU 4 continues to wait until online authentication becomes possible.

For example, when the DCU 4 detects that the power switch of vehicle 2 has been turned off without being authenticated by the authentication unit 4b, the DCU 4 determines NO in S16 and determines YES in S19. As a result, even when alternative authentication by the alternative authentication unit 4c has been performed for the target fee-based function, the DCU 4 disables the alternative authentication, which is performed by the alternative authentication unit 4c, on the condition that the power switch is turned off.

The DCU 4 holds the determination result performed by the alternative authentication unit 4c as to whether execution of fee-based function is valid until the vehicle 2 is stopped and the power supply to the vehicle 2 is turned off while authentication by the authentication unit 4b is not possible. For example, the fee-based function may be effective before driving begins, but may expire while driving of the vehicle 2.

In this case, the DCU 4 may determine that the fee-based function can be executed without any condition while the vehicle 2 is in traveling state. When the power switch is turned off, the unconditional permission by the alternative authentication unit 4c is disabled. When the power switch of vehicle is turned on again, authentication by the authentication unit 4b is required. After the power switch is turned on again, authentication by the authentication unit 4b or alternative authentication by the alternative authentication unit 4c becomes necessary again, so that the contract for fee-based function can be complied with. When the DCU 4 determines that the vehicle 2 is stopped, the DCU may notify the HCU 3 and the display device 11 or the portable terminal 9 that authentication by the authentication unit 4b has failed, and immediately stop the fee-based function.

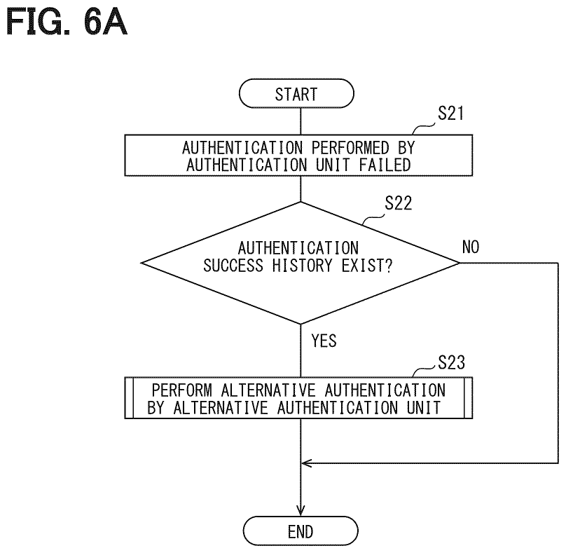

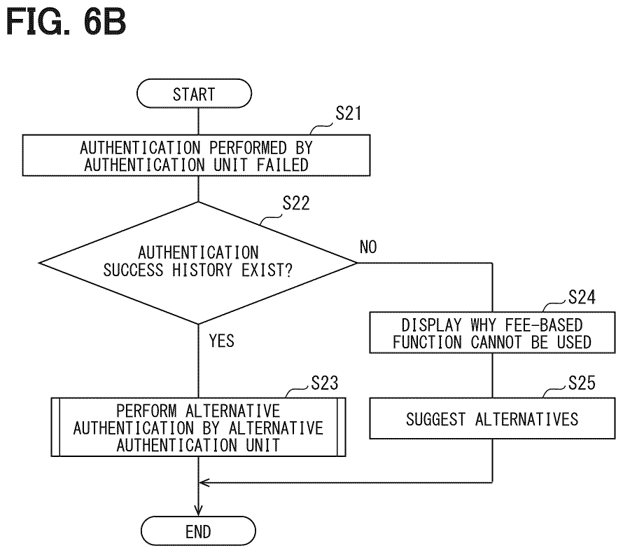

The DCU 4 may use the alternative authentication unit 4c to determine whether the validity period of fee-based function has expired using a GPS or a timer, and determine whether the fee-based function can be executed. As shown in FIG. 6A, the alternative authentication unit 4c may use authentication history information of fee-based function stored in the database 4e to determine whether the fee-based function can be executed.

Suppose that the authentication unit 4b fails to authenticate the fee-based function in S21 of FIG. 6A due to a reason such as the DCU 4 fails to establish a communication connection with the network 7, the DCU 4. At this time, by referring to the database 4e, if the alternative authentication unit 4c determines that there is successful history of authentication in the past, the alternative authentication unit 4c may authenticate the function in S23. In response to the alternative authentication being successful, the target fee-based function is activated (see S35, S45, S56).

When the authentication history indicates that the authentication by authentication unit 4b is failed in the past, the DCU 4 determines NO in S22 and does not permit alternative authentication by the alternative authentication unit 4c. At this time, the DCU 4 may only accept authentication by the authorized authentication unit 4b. When the authentication history indicates that authentication has never been successful, the target fee-based function is a function for which no fee has been charged in the past. For this reason, the alternative authentication is disabled. As a result, it is possible to prevent unauthorized use of fee-based functions that should not be available.

FIG. 6B shows a modification of FIG. 6A. When the DCU 4 determines that there is no history of successful authentication as shown in S22 of FIG. 6B, the DCU 4 may display, on the display device 11, the reason why the function cannot be used in S24. The DCU 4 controls the display device 11 to display a message via the HCU 3. In this case, the DCU 4 may display a message such as “This is a function that you have never used before and has no history of being authorized in the past, so you cannot use this function.” This allows the vehicle occupant to understand the reason why use of the function is disabled, and can avoid that the vehicle occupant feels distrust about the function. Also, the DCU 4 may notify a message such as “Would you like to be charged after communication is restored?” in S25 of FIG. 6B and suggest use of the function by charge.

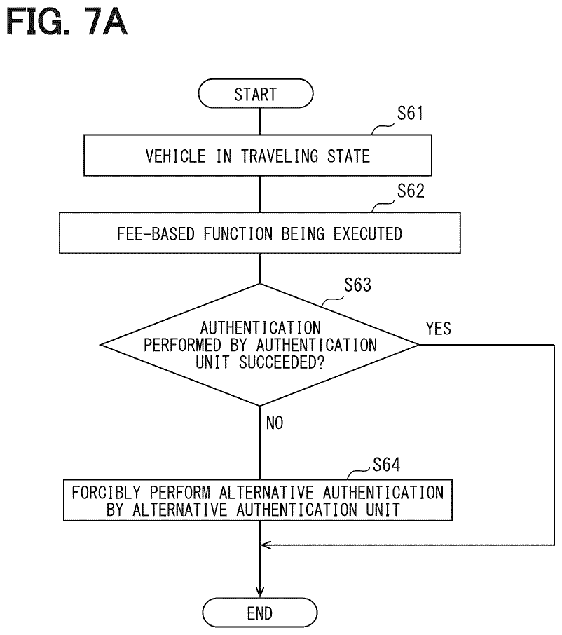

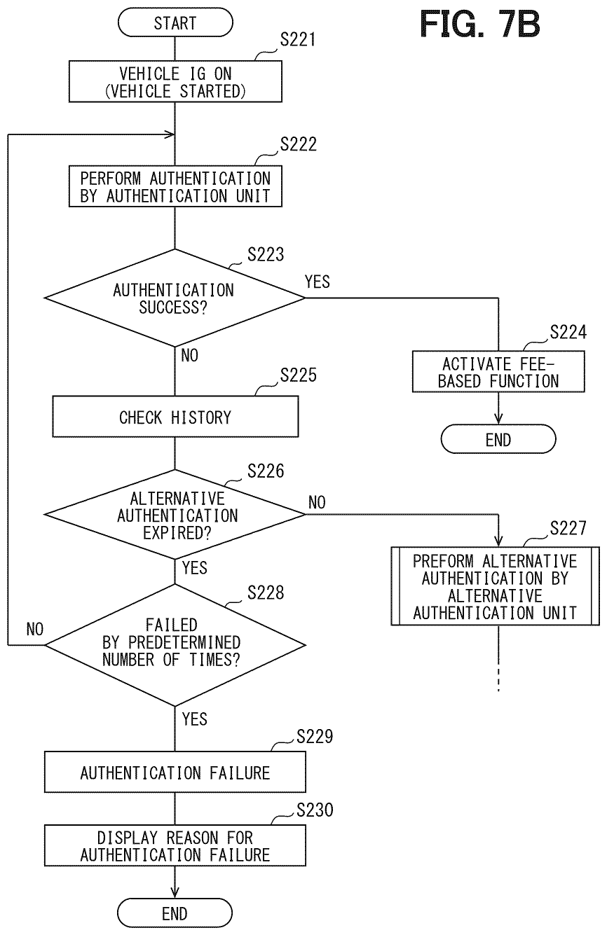

As shown in FIG. 7A, when the vehicle 2 is determined to be in traveling state in S61 and the fee-based function is being executed in S62, the DCU 4 may determine in S63, by the authentication unit 4b, whether the fee-based function can be executed. When the DCU 4 fails to determine execution of the fee-based function in S63, the DCU 4 may forcibly determine in S64 that the fee-based function can be executed using the alternative authentication unit 4c during the traveling of vehicle 2.

While the vehicle 2 is traveling, the DCU 4 may assume that the determination failure for execution of fee-based function is caused by a deterioration in communication condition of radio signals, and may forcibly allow the alternative authentication, which is performed by the alternative authentication unit 4c, and continue to use the fee-based function. This enables the occupant to continually use the target fee-based function.

As described above, according to the present embodiment, when communication with the external management server 8 cannot be established and the network connection for the fee-based function is interrupted, the authentication unit 4b fails to determine whether the fee-based function can be executed via the network communication unit 4a. In this case, the alternative authentication unit 4c performs the alternative authentication. Thus, the alternative authentication can be performed even in an offline environment.

### Modification Example of First Embodiment

A modification example is shown in FIG. 7B. The following will describe a process at the startup time of vehicle 2. When the ignition switch of the vehicle 2 is turned on and the vehicle 2 starts up, the DCU 4 performs authentication using the authentication unit 4b in S222, and determines in S223 whether the authentication is successful. When the authentication is successful in S223, the DCU 4 activates the fee-based function in S224. When the authentication is failed in S223, the DCU 4 checks the authentication history of alternative authentication unit 4c in S225.

The DCU 4 checks the authentication history of the alternative authentication unit 4c at the time the ignition switch was last turned off. Specifically, the DCU 4 checks whether the validity period of fee-based function, which has been enabled by the alternative authentication unit 4c, is expired or not. For example, when the time of alternative authentication performed by the alternative authentication unit 4c is determined to be within the validity period in S226, the DCU 4 controls the alternative authentication unit 4c to perform the alternative authentication in S227. Thus, it is possible to provide the alternative authentication function to the fee-based function, thereby improving user convenience of the fee-based function.

When the time of alternative authentication performed by the alternative authentication unit 4c is determined to be expired in S226, the DCU 4 retries the alternative authentication, and repeats the retries from S222 until the number of retries exceeds a predetermined number of times in S228. When the DCU 4 determines that the authentication has failed by the predetermined number of times as a result of multiple retries, the DCU 4 controls the display device 11 to display the reason for the authentication failure via the HCU 3 in S230. For example, the HCU 3 may display a message such as “Authentication failed the last time the power was turned off, so the function is not ready for unconditional use” on the display device 11 to inform the occupant of the reason for the authentication failure. This enables the occupant to understand the reason why the fee-based function cannot be used.

When the power supply to the DCU 4 is turned off with the authentication of fee-based function by the authentication unit 4b being remained as failed, and then the next time authentication also fails as shown in S223 to S230 of FIG. 7B after the power is turned on, the DCU 4 should notify the occupant via the HCU 3 and the display device 11 of the fact that the fee-based function, for which authentication by the authentication unit 4b has failed, cannot be used, along with the reason for the authentication failure. With this configuration, the occupant can understand the reason why the fee-based function cannot be used.

### Second Embodiment

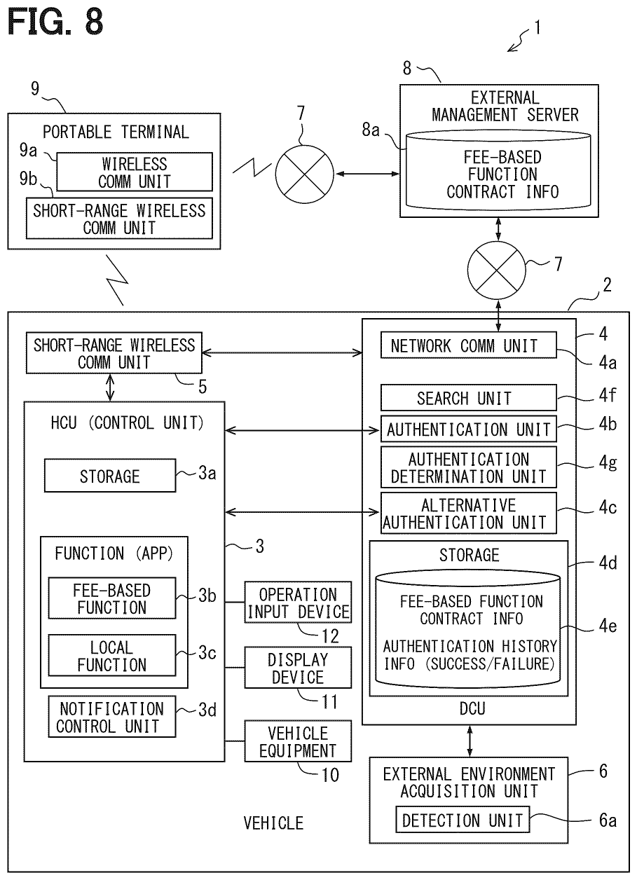

The second embodiment will be described with reference to FIG. 8 to FIG. 10C. In the second embodiment, when the authentication of fee-based function has failed, an alternative function that substitutes for the fee-based function is searched for and the alternative function is executed.

In the present embodiment, as shown in FIG. 8, the DCU 4 has an application function serving as a search unit 4f that searches for the alternative function. The DCU 4 also has an application function serving as an authentication determination unit 4g. The HCU 3 has an application function serving as a notification control unit 3d. The other configuration is similar to that of the first embodiment, and hence the detailed description will be omitted.

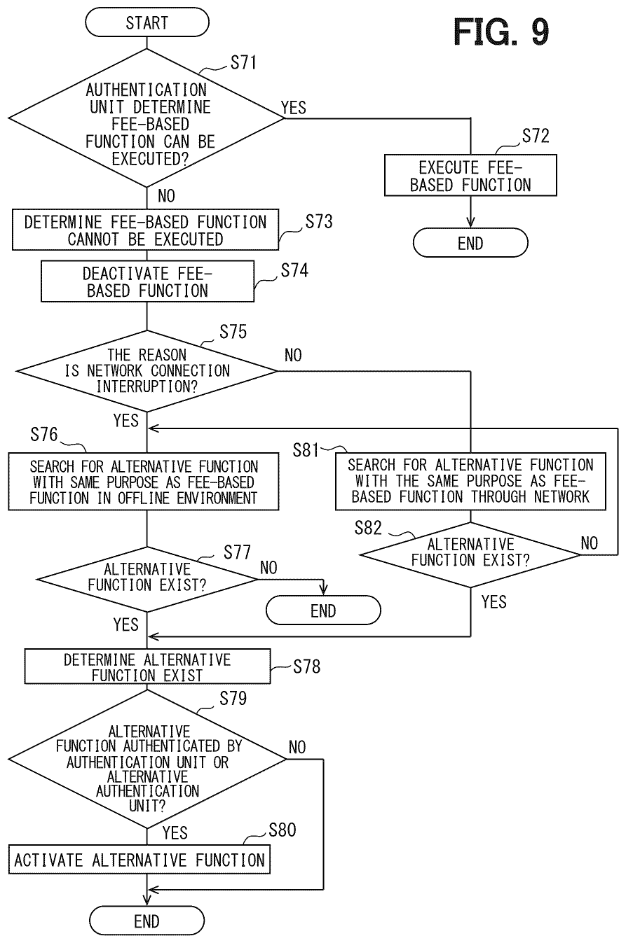

As shown in FIG. 9, in S71, the DCU 4 determines whether the target fee-based function can be executed by authenticating fee-based function using the authentication unit 4b via the network communication unit 4a. In response to the DCU 4 determining that the fee-based function can be executed, the DCU 4 determines YES in S71, and executes the target fee-based function in S72.

In S71, as a determination result of whether the fee-based function can be executed, when the DCU 4 determines that the execution of target fee-based function is not allowed in S73, the DCU 4 disables the fee-based function in S74. Thereafter, regardless of the reason for disconnection to the network 7, the DCU 4 searches for an application that executes an alternative function to satisfy the same condition as the purpose of use of the fee-based function, by the search unit 4f in S76 or in S81.

When the authentication section 4b determines that the fee-based function cannot be executed due to the disconnection of network 7 in S75 (S75: YES), the DCU 4 determines that network connection via the network communication unit 4a is not available. In this case, the DCU 4 may search for an application with an alternative function that can be executed in the offline state, for example, in the local environment, in S76 using the search unit 4f. When the DCU 4 determines that the fee-based function cannot be executed due to the disconnection of network 7 in S75, the DCU 4 searches for the alternative function under offline environment in S76. Herein, the alternative function has the same purpose as the fee-based function.

The DCU 4 searches for an application that is pre-installed in the local environment of the vehicle 2, for example, in the storage 4d of the DCU 4. If an application having an alternative function is stored in the storage 4d, the DCU 4 determines that the alternative function can be executed. When performing an offline search, the DCU 4 may search for applications installed in the storage 3a of the HCU 3.

When the DCU 4 determines that the connection is established with the external management server 8 via the network 7 but the authentication unit 4b determines that the fee-based function cannot be executed due to, for example, expiration of contract or failure to authenticate personal identification information, then the result in S75 is also NO. At this time, the DCU 4 may search for an application with an alternative function that can be executed free of charge or with fee charge from the external management server 8 or the like in S81 using the search unit 4f.

When the DCU 4 determines in S75 that the cause is not an disconnection to the network but rather an expiration of contract or a failure in personal authentication, the DCU searches, in S81, through the network 7 for an application that has an alternative function with the same purpose as the fee-based function. When the DCU 4 searches through the network 7 using the search unit 4f, the DCU 4 may search for the application from the external management server 8 or may search for the application from another server (not shown) through the network 7. The alternative application may be a free application or an application having the same functions as that stored offline in the storage 4d.

The DCU 4 may search for, using the search unit 4f, an alternative function among functions provided in the portable terminal 9, which is provided as an external terminal. The communication method during the search may be a local communication connection via the short-range wireless communication units 5 and 9b, or a communication connection via the network communication unit 4a and the network 7 via a network server (not shown).

If it is possible to connect to the network 7, subscription-based application with equivalent function may also be considered as target function, under a condition that the subscription-based application has the same purpose and same functionality. In this case, the DCU 4 may determine whether an application for fee-based function of the subscription service is available.

Therefore, the application that performs the alternative function may be an application for a subscription service with fee-based function, an application for one-time fee-based function (known as shareware), or an application for non-fee-based function (known as freeware).

As a specific example of application, if the fee-based function under contract is a driving assistance application that includes a driving control function for the vehicle 2, such as an application that has a driving assistance function related to security or safety, the DCU 4 uses the search unit 4f to search for a driving control application that has the same purpose as the driving assistance.

When the fee-based function under contract is an application that has a navigation function for displaying a map on the display screen of the display device 11 and providing guidance to a destination, the DCU 4 uses the search unit 4f to search for a map display application with different title or application with different navigation function.

As the navigation function, for example, there is a fee-based function that accurately searches the network 7 for high-resolution 3D map display and guidance to a place where various services can be provided. As the alternative function, a function that displays high-resolution map and route guidance in 2D map display is provided. There is also a local function that displays a simplified map and provides geographical guidance using only simple symbols. As described above, the functions can be divided into multiple levels according to the provided services.

Even if it is difficult to authenticate a fee-based function for which a contract has been previously made, the DCU 4 can search online for applications of other functions from the network 7 using the network communication unit 4a. The DCU 4 can perform offline search for applications pre-stored in the storages 3a and 4d. In this way, functions can be searched step by step.

For example, when the HCU 3 is unable to display only the map portion of the navigation function, the DCU 4 may search for only the map portion from the local storages 3a and 4d. At this time, the HCU 3 may read out only the map portion searched by the DCU 4 from the storages 3a and 4d and display the searched map portion on the display screen of the display device 11.

For example, the DCU 4 may also search for the function of application that authenticates a person in a step-by-step manner. For example, a person authentication application may have fee-based function with relatively high-resolution recognition accuracy, or a local function with low-resolution recognition accuracy. The same applies to such a person recognition application.

The DCU 4 may download and store, in advance, in the storage 4d an application that allows the execution of alternative function when authentication by the authentication unit 4b fails. Then, the DCU 4 can immediately search for, using the search unit 4f, the alternative function that is permitted to be executed.

When the target fee-based function application is an application for comfortability related to entertainment that pursues comfortability in the compartment of the vehicle 2, the search unit 4f searches for an application having a comfortability function with the same purpose. The DCU 4 may search within the same category or genre using the search unit 4f. When the authentication unit 4b of the DCU 4 determines that the fee-based function cannot be executed, the HCU 3 may execute an application having alternative function searched for by the search unit 4f of the DCU 4.

The following will describe a specific example of the alternative function. The alternative function for the fee-based function may be one that completely replaces the target fee-based function by level of 100% or one that only partially replaces the target fee-based function. Typically, the fee-based functions tend to be more powerful and advanced than free applications. For this reason, even when an attempt is made to implement an alternative function for fee-based function using only free applications, it is unlikely that 100% reproduction will be possible.

When the DCU 4 is to completely replace the fee-based function by level of 100%, the DCU 4 may search for another fee-based application and execute the searched application. For example, the DCU 4 may search for and use another audio application, which has radio function in addition to the music playback function, as another fee-based application. When the function of audio application becomes unavailable due to the expiration of authentication, the DCU 4 may use a different music application. When searching for another music application, an application that can both play music and receive radio may be searched as another music application.

When replacing partial function of the application, the DCU 4 may search for an application that is pre-installed as defaults in the storages 3a, 4d of the HCU 3 and DCU 4, search for free application from the system, or search for and use other fee-based application that requires a lower fee than the usage fee of expired fee-based function or than a specified fee.

When substituting partial function, the DCU 4 may search for and use an application that only has a music playback function but cannot receive radio signals. When the fee-based function cannot be used and an alternative function is searched, an application that only has a music playback function and cannot receive radio signals may be searched for and used. As another example, an audio application having both a music playback function and a radio function may be searched for first, and then when the audio application having both functions becomes unusable due to an expiration of validity, an application having only a music playback function without receiving radio may be searched for and used.

In this case, when the application with the alternative function searched for is an application related to safety or security, the application may be assigned with a high priority. Thus, other low priority applications may be stopped, and applications determined to have low priorities may be deleted (trimmed) in order to free up memory capacity.

The DCU 4 may execute multiple alternative functions to reproduce the fee-based function that is determined to be not executable. In this case, the fee-based function may be reproduced by executing, in combined manner, multiple applications each of which can substitute for partial function of the fee-based function.

At this time, cooperation with the external portable terminal 9 may be performed, and further cooperation of multiple applications may be performed. For example, the HCU 3 may have a music playback function as a local function 3c, the portable terminal 9 may have a radio reception function, and the external management server 8 may have an audio setting function.

When transmitting, receiving, or arbitrating music content data, the DCU 4 may execute an add-on function for transmitting and receiving applications and data stored in various locations within the system, and further adjusting the applications and data. In this case, an application having an adjustment function may also be searched for from an external portable terminal 9 or from an application server.

For example, when linking and arbitrating a navigation application having a navigation function and an audio application, an arbitrating application having an arbitration function that arbitrates the volume adjustment function for guiding to a destination by the navigation application and the volume adjustment function for playback of music by the audio application may be searched for. For example, the HCU 3 may receive the searched application from the DCU 4 and execute the arbitration application together with the navigation application and the audio application. The HCU 3 can then selectively announce route guidance and music within the vehicle compartment, allowing the occupant to comfortably obtain route guidance information and enjoy music at the same time. The cooperation and arbitration between the navigation application and the audio application is described as an example. As another example, an application that can adjust, cooperate, and link various applications may be searched for, and the searched application may be acquired as the application having the alternative function.

When the DCU 4 fails to search for an alternative function through the network 7 using the search unit 4f in S81, the DCU 4 determines NO in S82 and returns to S76 to search for an alternative function that can be executed in an offline state.

When the DCU 4 determines in S78 that the alternative function can be executed after searching for an application for the alternative function, the authentication unit 4b determines in S79 via the network communication unit 4a whether the alternative function can be executed. When the authentication unit 4b determines that the application can be executed as determination result of S79 is YES, the DCU 4 activates the application of the alternative function in S80. After that, the HCU 3 executes the application having the alternative function. with this configuration, the user can use the alternative function, improving user convenience. When the DCU 4 is unable to perform online authentication using the authentication unit 4b in S79, the DCU 4 may perform, in offline manner, the alternative authentication using the alternative authentication unit 4c.

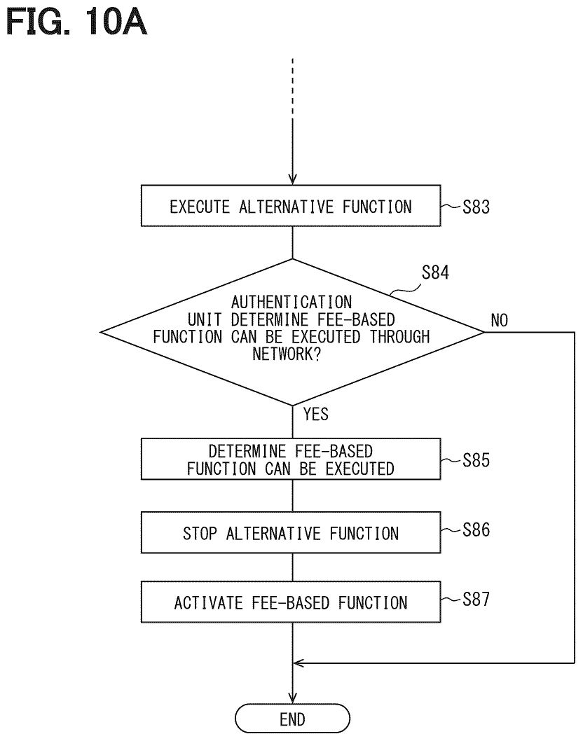

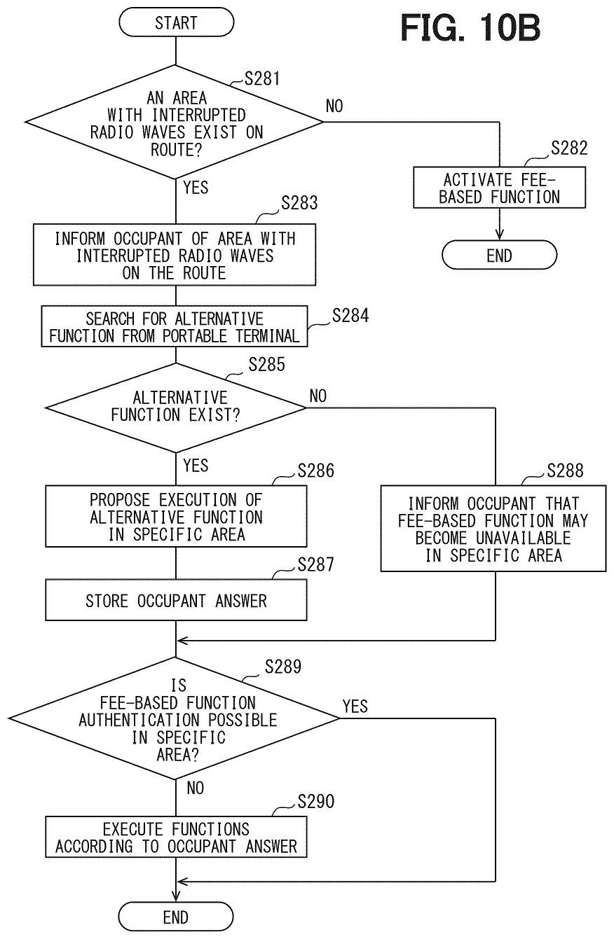

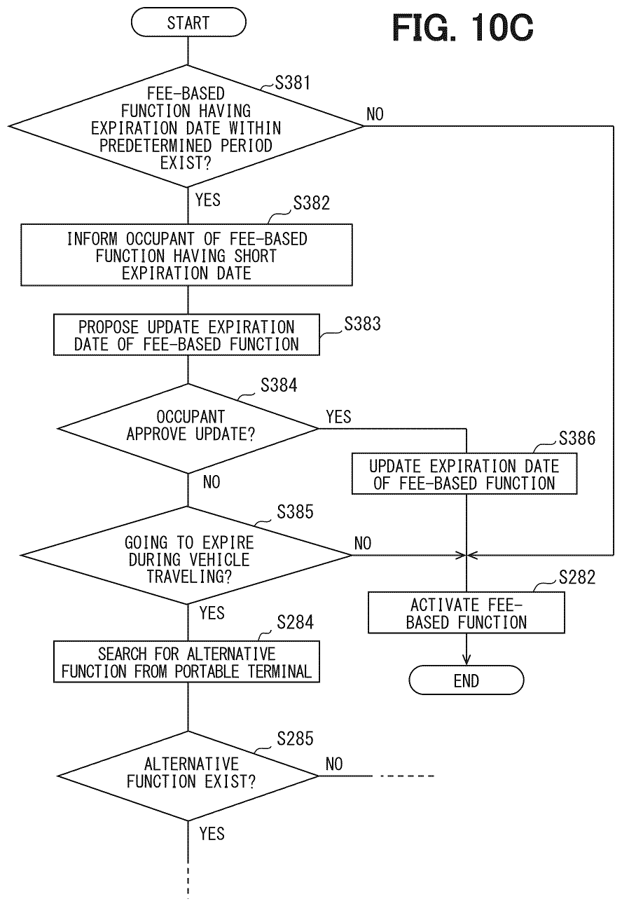

When an occupant or user starts using an application with an alternative function, the DCU 4 executes the process shown in FIG. 10A. The DCU 4 executes the application having alternative function searched by the search unit 4f in S83. When the alternative function is substituting for the fee-based function, it is advisable to notify the occupant that the fee-based function has been disabled due to an expired authentication, so that the occupant is made aware of use of the alternative function. Examples of such methods include (1) graying out the icon of the corresponding fee-based function, (2) removing the icon of the corresponding fee-based function from the menu screen, and (3) displaying information on an area of the screen indicating that the fee-based function has been disabled. The displayed information may be text information or a mark indicating that the fee-based function has been invalidated.

The amount of information that can be displayed on the display screen of display device 11 is limited. The HCU 3 periodically checks the icons displayed on the display device 11, and when the number of icons increases beyond a predetermined amount, the display information is reduced to secure a display area or less important display information is deleted to properly organize the display information.

The HCU 3 may display link information for accessing an authentication and registration site of the fee-based application. When checking whether the authentication of fee-based function has expired, the occupant can select a link to an inquiry destination and use the browser function of the HCU 3 or the display device 11 to access the registration site of fee-based function. Furthermore, the telephone number, URL, and QR code (registered trademark) of the helpdesk may be displayed. Even when the DCU 4 of vehicle 2 cannot connect to the network 7, the occupant may be able to deal with the situation using the communication function of the portable terminal 9 as long as the information is displayed. As a result, even when the DCU 4 becomes unable to connect to the network 7, the occupant can access the registration site via the portable terminal 9, thereby eliminating the occupant to feel anxiety.

The DCU 4 may determine in S84, using the authentication unit 4b, whether to authenticate the fee-based function, even while the application having alternative function searched for by the search unit 4f in S83 is being executed. When the DCU 4 determines in S85 that authentication of fee-based function is succeeded, the HCU 3 may stop execution of the application having alternative function in S86, and activate the fee-based function in S87. The HCU 3 may then prioritize the execution of application having the fee-based function. As a result, even while an application with alternative function is being executed, if authentication of an application having the regular fee-based function successes, the application having the fee-based function may be executed with higher priority, thereby improving user convenience.

As another example, once the HCU 3 has executed the alternative function, the priority of execution of alternative function may be increased over the fee-based function of subscription service. The DCU 4 may store, in the storage 4d, a change in priority, and may refer to the priority stored in the storage 4d to determine which function to be executed. In this case, the HCU 3 may set a higher priority to the execution of alternative function over the fee-based function.

As described above, according to the present embodiment, the DCU 4 searches for an alternative function using the search unit 4f, and when the authentication unit 4b determines that the fee-based function cannot be executed, the HCU 3 executes the alternative function searched for by the search unit 4f. Therefore, even when license authentication of fee-based function of subscription service fails within vehicle 2, the alternative function can be used to provide functionality at the same level as the fee-based function of subscription service, or at the minimum level required by the occupant.

A modification example of the second embodiment will be described below with reference to FIG. 10B and FIG. 10C.

### First Modification of Second Embodiment

A first modification of the second embodiment will be described with reference to FIG. 10B. The DCU 4 uses the authentication unit 4b to determine whether to execute the fee-based function. If there is no area where the radio signal is interrupted while the navigation application is being executed (NO in S281), the fee-based function can be activated as usual in S282. There may exist an area where the radio signal is interrupted is estimated, in advance, in a planned route which is guided by the navigation (YES in S281). The DCU 4 determines, in advance, the possibility of network connection failure, and thereby determines in advance that authentication of fee-based function by the authentication unit 4b will be impossible.

In such a case, the DCU 4 notifies the occupant in advance via the HCU 3 that there is an area on the route where radio signals will be interrupted (S283), and then searches for an alternative function from the portable terminal 9 (S284). Then, the DCU 4 determines in S285 whether an alternative function is available. In response to determining that an alternative function is available, in S286, the DCU 4 proposes to the occupant to execute the alternative function in the interrupt area. At this time, when the DCU 4 receives an operation input from the operation input device 12, the DCU 4 stores the response from occupant in the storage 4d.

In S285, when the DCU 4 determines that there is no alternative function, the DCU 4 notifies the occupant via the HCU 3 and the display device 11 in S288 that the fee-based function may be unavailable in the specific area. In S289, when the DCU 4 determines that the fee-based function can be authenticated after the vehicle reaches the specific area, the DCU exits from the process and executes the fee-based function as usual. In S289, when the DCU 4 determines that the fee-based function cannot be authenticated because the vehicle has entered the specific area, the DCU 4 takes action in S290 in accordance with the response of occupant that has been stored in advance in the storage 4d.

For example, when a set route includes a radio signal interrupted area or the validity period of fee-based function expires after midnight of 12 o'clock, the DCU 4 can operate normally even when the vehicle approaches the specific area as long as the authentication of fee-based function is possible. When the DCU 4 determines that the fee-based function cannot be authenticated because the vehicle has entered the specific area, the DCU 4 takes action, in S290, in accordance with the response of occupant stored, in advance, in the storage 4d. In this case, even when the fee-based function becomes unavailable, the alternative function that is set, in advance, by the occupant can be executed, thereby improving the user convenience.

### Second Modification of Second Embodiment

As shown in FIG. 10C, the process may be executed in S381 to S386 before searching for an alternative function from the portable terminal 9 in S284. The DCU 4 refers to the storage 4d and determines in S381 whether a fee-based function with a validity period within a predetermined period (for example, one day, two days, one week, etc.) is registered. When the expiration date of fee-based function is determined to be within a predetermined period in S381, the DCU 4 notifies the occupant in S382 that there is a fee-based function whose expiration date is about to expire, by using the function of notification control unit 3d of the HCU 3. Then, the DCU 4 proposes updating the expiration date of corresponding fee-based function in S383. When the occupant confirms the update, that is, does not deny the update, the DCU 4 communicates with the external management server 8 in S386 to update the expiration date of fee-based function and stores the updated expiration date in the storage 4d.

When the route is set by the navigation function, if it is expected that the validity period of fee-based function will expire during driving, the HCU 3 searches for an alternative function from the portable terminal 9 in S284. The subsequent process is similar to the process in S285 to S290 in FIG. 10B, and therefore detailed description thereof will be omitted.

According to this modified example of second embodiment, the network communication unit 4a communicates via the network 7 with the external management server 8 that stores information about fee-based function that can be executed by an occupant of the vehicle 2, and the authentication unit 4b determines whether the fee-based function can be executed via the network communication unit 4a. The authentication determination unit 4g determines in advance the possibility of at least one of the following situations: a bad network connection, or the expiration of fee-based function, and thereby determines in advance that authentication of the fee-based function by the authentication unit 4b will be impossible. The notification control unit 3d is configured to notify the occupant when the authentication determination unit 4g determines that authentication by the authentication unit 4b is impossible.

The DCU 4 searches for an alternative function having the same purpose of use as the fee-based function using the search unit 4f. When the authentication determination unit 4g determines that authentication by the authentication unit 4b is impossible due to a bad network connection, the notification control unit 3d suggests execution of the alternative function that has been searched for. When the DCU 4 determines that there is a high possibility of interruption to connect to the network 7, for example, because a planned route includes an area where the radio signals are interrupted, the DCU 4 determines that the network will not be usable for a long period of time and suggests execution of an alternative function. With this configuration, it is possible to make suggestion to the occupant about execution of an alternative function even if the fee-based function becomes unavailable for a long period of time.

When using the function of search unit 4f, the DCU 4 may add the occupant preference as a condition for determining the alternative function. For example, in a case of audio applications, the DCU 4 may search for an application with alternative function that is strong in deep bass or treble, or application with alternative function that emphasizes preferences for music genres such as J-POP and jazz. In the navigation function, the DCU 4 may set the background color to pastel or vivid, to have the occupant input these preferences in advance on an option screen, and to learn the audio setting input by the occupant.

The DCU 4 searches for an alternative function using the search unit 4f. When the DCU 4 determines that authentication by the authentication unit 4b will become impossible due to the expiration of fee-based function, the DCU 4 may suggest to the occupant by the notification control unit 3d about update of the fee-based function. For example, when the expiration date expires during the date changes beyond 12:00 p.m., or when the expiration date expires while the vehicle 2 is traveling, the DCU 4 may suggest to the occupant that the expiration date of fee-based function should be extended by update. The DCU 4 may also propose an extension of the validity period to the occupant when the expiration date is going to expired soon, such as within one or two weeks.

### Third Embodiment

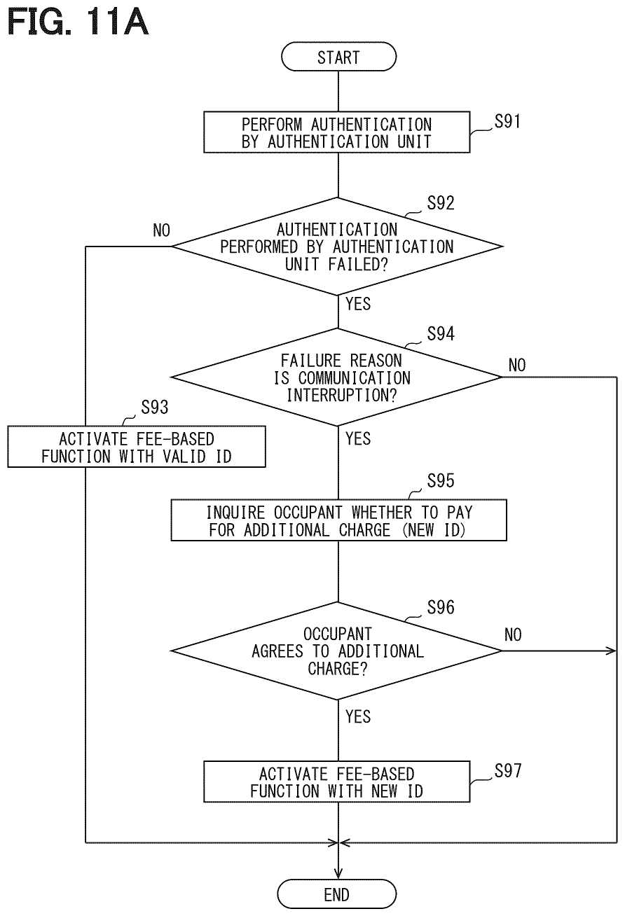

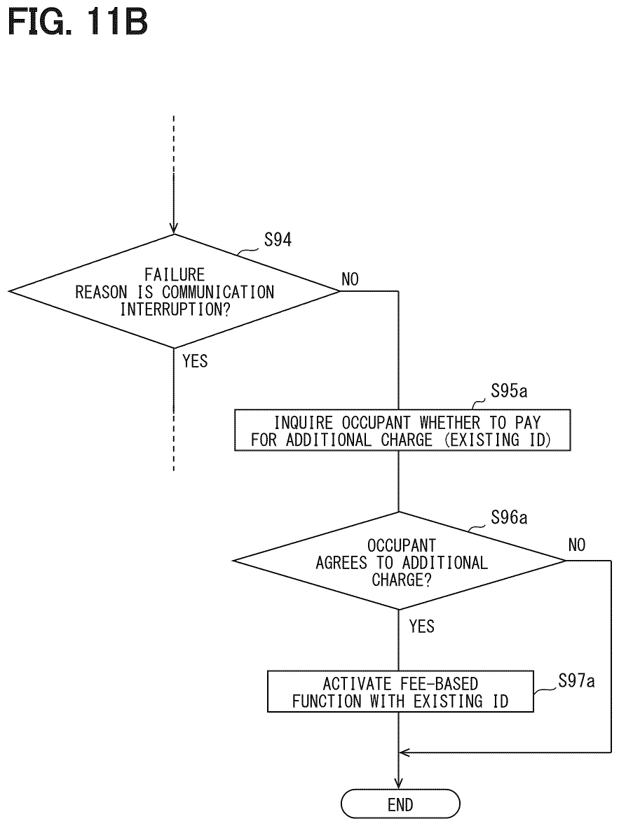

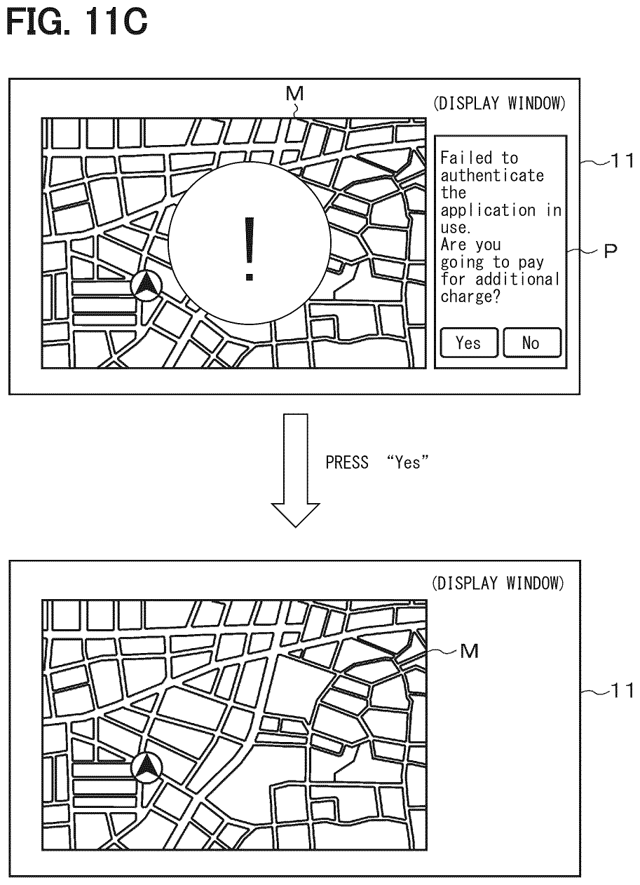

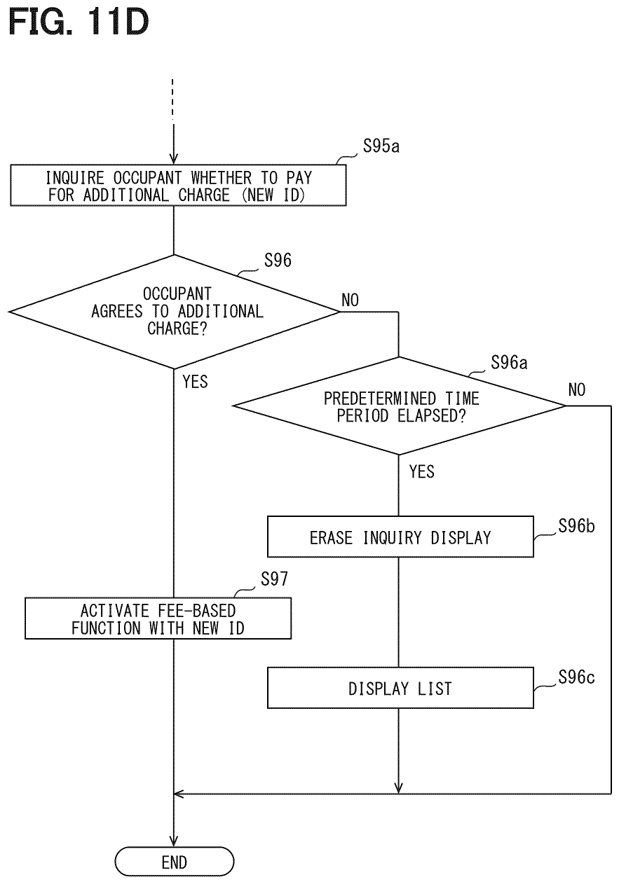

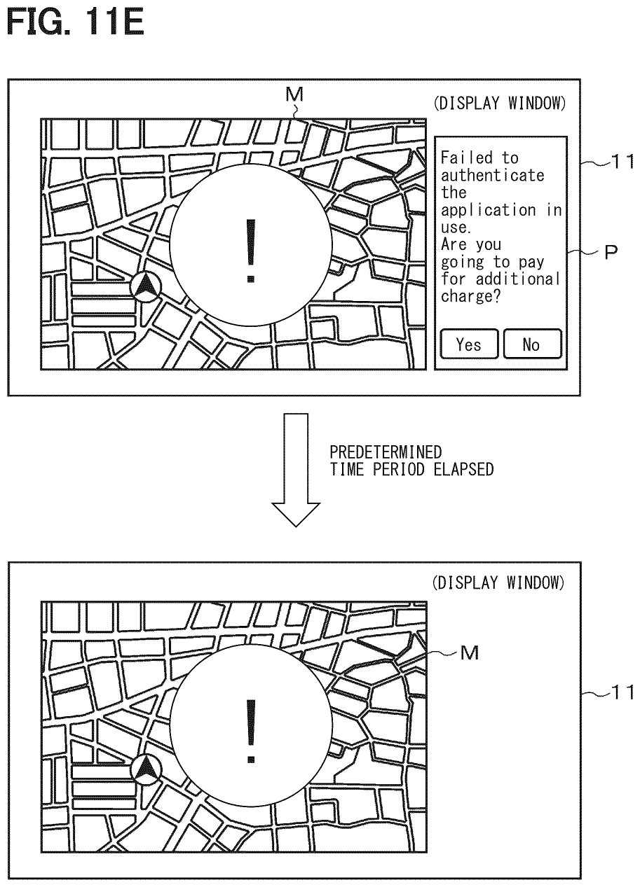

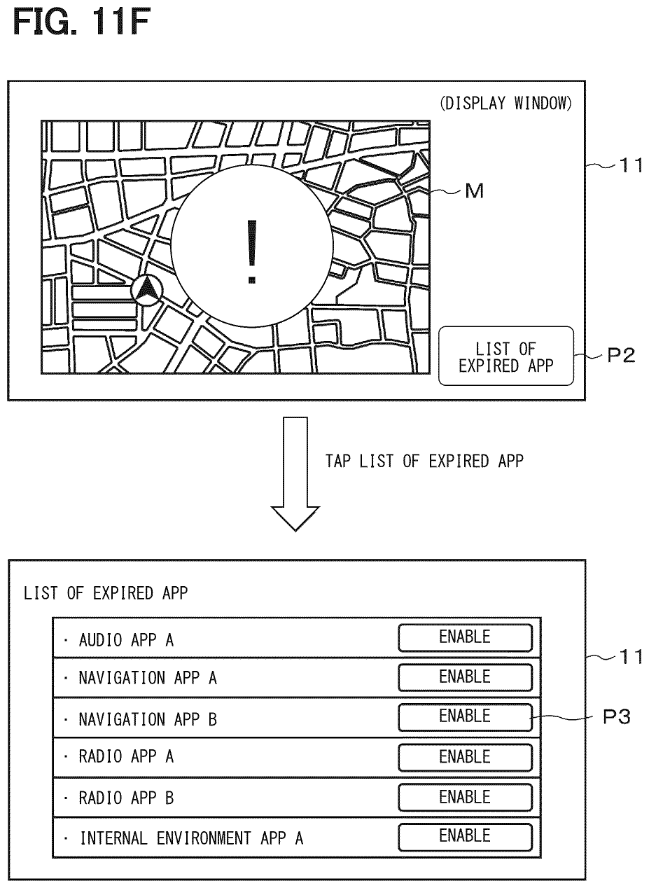

The following will describe a third embodiment with reference to FIG. 11A to FIG. 13B. In the third embodiment, differences from the first embodiment or second embodiment will be mainly described. As shown in FIG. 11A, the DCU 4 performs authentication via the network 7 using the authentication unit 4b in S91. In S92, the DCU 4 determines whether the authentication by the authentication unit 4b has been successful.

When the authentication is successful in S92, the DCU 4 activates the fee-based function using the authenticated regular ID (personal authentication identification information) in S93. In this case, the user can use the fee-based function as usual.

When the authentication by the authentication unit 4b fails in S92, the DCU 4 determines in S94 whether the failure is due to a communication interruption caused by a deterioration of communication environment. When the communication has not been interrupted, the DCU 4 determines NO in S94 and determines that personal authentication has failed. When the reason for the authentication failure in S92 is a communication interruption, the DCU 4 inquires the user in S95 about whether to request additional charges for the fee-based function by displaying the inquiry on the display device 11 via the HCU 3 or by communicating with the portable terminal 9. For example, during a trial period of, for example, one month, the fee-based function or other fee-based functions may be used free of charge. In this case, the user may be notified of this fact and the DCU 4 may inquire the user about whether to pay for the additional charge for continued use. When the DCU 4 does not accept an approval operation via the operation input device 12 for a predetermined period of time, the DCU 4 may erase the display of whether or not there is an intention to charge additional fee.

With this configuration, the DCU 4 can determine in S96 whether the user has an intention to pay for the additional charge. When the DCU 4 receives an input indicating an intention to pay for the additional charge from the operation input device 12 or the portable terminal 9, the DCU 4 determines YES in S96 and determines that the user intends to pay for the additional fee for use of the fee-based function. For example, when identification information such as a credit card number is stored in advance in the storage 3a, 4d within the vehicle 2, the DCU 4 may assume that this is a user intention to pay for the additional charge and automatically determine that there is an intention to pay for the additional charge.

In S97, the DCU 4 performs additional charging, for example, by credit card payment, via the short-range wireless communication unit 5 and the portable terminal 9, and activates the fee-based function using the personal authentication information of the new ID. Thereafter, the corresponding fee-based function may be executed by the HCU 3 or the like. When the certificate is stored in the portable terminal 9, the portable terminal 9 may transmit the certificate to the vehicle 2, thereby enabling the authentication even in offline environment.

In S94 of FIG. 11A, if the reason for failure is not a communication interruption, the process may be ended as shown in FIG. 11A. As shown in S95a of FIG. 11B, the DCU 4 may link the existing ID to inquire of the occupant as to whether or not the occupant pays for the additional charge. When the occupant indicates an intention to pay for the additional charge in S96a, the DCU 4 may activate the fee-based function using the existing ID in S97a.

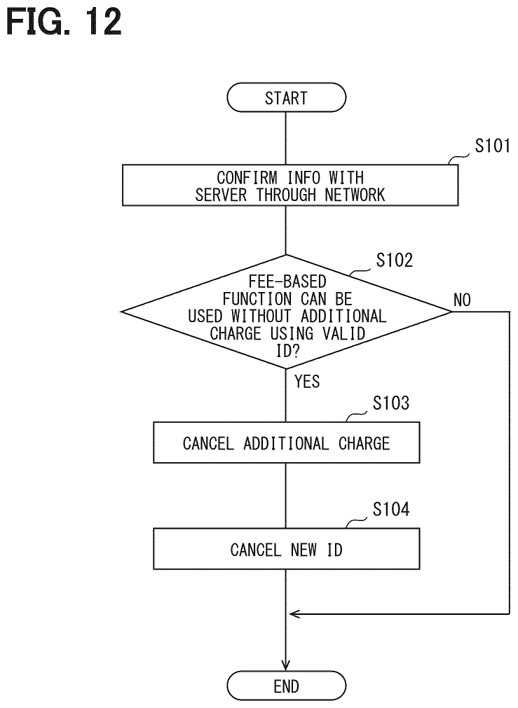

In response to determining that the occupant has the intention to pay for the additional charge, the DCU 4 performs online authentication via the network communication unit 4a in S101 of FIG. 12 even while the HCU 3 is executing the corresponding fee-based function. When the communication environment of network 7 is recovered to a good condition, the DCU 4 checks the information stored in the database 8a of the external management server 8 in S101.

In S102, the DCU 4 determines whether the corresponding fee-based function can be executed without additional charge. When the DCU 4 determines in S102 that the function can be used without additional charge, the DCU 4 may cancel the additional charge for the corresponding fee-based function in S103 and cancel the occupant's decision to pay for the additional charge. The new ID may be cancelled in S104. Cancellation of the new ID is optional, and should be done after confirming the occupant's intention to cancel the new ID. Thereafter, the HCU 3 can execute the corresponding fee-based function using the existing authorized ID. As a result, the occupant can effectively utilize the existing fee-based function based on the authorized ID. For example, the period of use for which additional charges is applied may be compared with the expiration date before the authentication expired. When the period of use is outside the expiration date, additional charges may be required for the user.

When the DCU 4 determines YES in S102 and determines that a double charge has occurred, the DCU 4 may execute a refund process. When the charge is cancelled in S103 and the new ID is deleted in S104, the occupant may be notified of this fact via the display device 11. In this case, the message may be “You have been charged twice, so a refund is going to be made,” or “You have already been charged, so no additional charge is made. The function is now functioning without any additional charge.” In this case, the occupant can check whether he or she ended up being charged in vain, whether the charge is refunded after being charged erroneously, or whether the charge is not made at all, which prevents the occupant from feeling anxiety.

### First Modification

### (Button Operation Made by Occupant and Display Content on Display Device 11 in Vehicle Stop State, Automated Driving State, or Traveling State)

For example, as shown in S94 of FIG. 11A, when the authentication by the authentication unit 4b fails due to a communication interruption, the DCU 4 may inquire the occupant whether to pay for the additional charge. As shown in S94 of FIG. 11B, when the authentication by the authentication unit 4b fails due to an error other than the communication interruption, the DCU 4 may inquire the occupant whether to pay for the additional charge in S95a.

For example, as shown in FIG. 11C, the HCU 3 displays an inquiry display P on the display screen of the display device 11 to prompt the occupant to input an operation. For example, in the example shown in FIG. 11C, a message “Failed to authenticate the application in use. Are you going to pay for additional charge? ‘Yes’ or ‘No’,” prompting the user to input an operation. At the same time, the HCU 3 may issue a warning by displaying an exclamation mark in the center of the map screen M while the navigation application is in executed state, and draws the occupant's attention to the inquiry display P. In this case, an operation input via the operation input device 12 is required.

When the occupant presses a predetermined button “Yes” via the operation input device 12 while the vehicle 2 is in stopped state, in automated driving state, or in manual driving state, the HCU 3 performs an additional charge, activates the fee-based function, and then erases the inquiry display P from the display screen as shown in FIG. 11C.

When the vehicle 2 is in manual driving mode, the occupant may do not press the predetermined button “Yes” via the operation input device 12. In this case, the fee-based function cannot be activated in the process shown in FIG. 11A no matter how much time passes. In such a case, as shown in S96a to S96c in FIG. 11D, when the HCU 3 determines that no operational instruction is accepted from the operation input device 12 for a predetermined period of time, the inquiry display P may be deleted. An example of display screen switch is shown in FIG. 11E.

When charge intention is not inputted by operation after a predetermined time has elapsed, a list of expired fee-based functions may be displayed on the display screen of the display device 11 by a pop-up in S96c of FIG. 11D. An example of the pop-up screen at this time is shown in FIG. 11F. As shown in the upper figure of FIG. 11F, the HCU 3 may prompt the occupant to temporarily input an operation by displaying a query display P2 for a “List of expired applications” button while leaving the warning display of an exclamation mark on the map screen M. When the HCU 3 detects that an inquiry display P2 of a list of expired authentication applications has been operated and input, the DCU 4 refers to the database 4e, and the HCU 3 selects an expired fee-based function stored in the database 4e and displays the selected function on the display screen. See the lower figure in FIG. 11.

When indication of intent to pay for additional charge is entered after a predetermined time period has elapsed, the HCU 3 may directly display a list of expired applications on the display screen of the display device 11, as shown in the lower figure FIG. 11F, without displaying the inquiry display P2 for a list of expired applications as shown in the upper figure of FIG. 11F.

The HCU 3 may allow the occupant to selectively determine whether to pay for the fee-based function. At this time, the HCU 3 displays a question mark P3 indicating “enable”, and when the question mark P3 is pressed, the HCU 3 selectively enables, that is, activates, the fee-based function. For each fee-based function, the billing period and history information thereof may be displayed to the user.

### Second Modification

### (Display of Charging Intention and Display Content of Display Device 11 in Traveling State of Vehicle)

A driver may feel difficult to express his or her intention to charging for additional fee while the vehicle is being driven manually. For example, when the DCU 4 needs to make a detailed inquiry to the occupant as to whether or not the occupant wishes to make an additional charge, the DCU 4 may need to input the operation by multiple times.

For example, this is the case when numbers or setting buttons are operated at least twice in succession to input credit card number information, expiration date (billing method), or billing conditions such as the expiration date and number of valid times required when adding a new fee-based function. The billing method here indicates, for example, information such as a credit card number and expiration date of the credit card. The billing condition may include, for example, a billing period in units of one day, one week, one month, three months, six months, or one year, or a number of times such as once or three times while vehicle 2 is running. In such a case, it is not preferable for the occupant of the vehicle 2, particularly the driver, to repeatedly perform manual operation inputs. Therefore, the whole details of authentication may be carried out by operating a single button.

In this case, the operation button of the operation input device 12 may be an icon displayed on the display screen of the display device 11 or a physical button provided on a steering wheel or the like. In the case of icon, the icon is not normally displayed on the display screen of the display device 11. The HCU 3 displays the icon on the display screen only in the event of an emergency, and the occupant can operate the icon to accept operational input via the touch panel. The icon may be configured to be displayed only when “an emergency operation is required from the occupant while the vehicle is in traveling state.”

For example, the physical button located around the steering wheel does not have the above-described function in normal state. The HCU 3 may display the role of physical button on the display screen of the display device 11 only when an emergency operation is required from the occupant while the vehicle is in traveling state, and may treat the result of pressing the physical button as an operation input result of the operation input device 12, indicating the decision on the charging intention.

When requesting approval in an emergency, operation input using a physical button or icon may be accepted on the condition that authentication by the authentication unit 4b has already expired. There is no need to provide a separate confirmation button for approving the charging intention of occupant. As a result, when the physical button or the icon is operated and the condition of S94 in FIG. 11A is satisfied, the process in S95 and S96 can be omitted, and the fee-based function can be immediately activated in S97. For example, in response to determining that the condition in S94 in FIG. 11B is not satisfied, the process in S95a and S96a can be omitted, and the fee-based function can be immediately activated in S97a.

By setting various authentications in advance, the charging intention including the above-mentioned charging method and charging condition may be set in advance in the storage 3a or storage 4d of the DCU 4 via the HCU 3. Alternatively, the charging intention including the charging method and charging condition may be set in the portable terminal 9. For example, the HCU 3 may display an option setting screen and allow the occupant to input the billing method and billing condition from the operation input device 12. The portable terminal 9 may display an option setting screen on the display screen, and allow the occupant to input the billing method and billing condition.

When charging intention is stored in advance in the storage 3a, 4d or the portable terminal 9 in above-described manner, the DCU 4 can refer to the charging intention information locally or via the network 7 and determine that there is a charging intention without carrying out various authentication procedures. In this case, when the charging intention is set in advance in the storage 3a, 4d or the portable terminal 9, in response to the condition of S94 in FIG. 11A being satisfied, the process in S95 and S96 can be omitted, and the fee-based function can be activated immediately in S97. In response to determining that the condition in S94 of FIG. 11B being not satisfied, the process in S95a and S96a can be omitted, and the fee-based function can be immediately activated in S97a.

### Third Modification

The DCU 4 may determine whether the occupant intends to approve additional charge for the fee-based function not only when online authentication by the authentication unit 4b fails, but also when offline alternative authentication by the alternative authentication unit 4c fails.

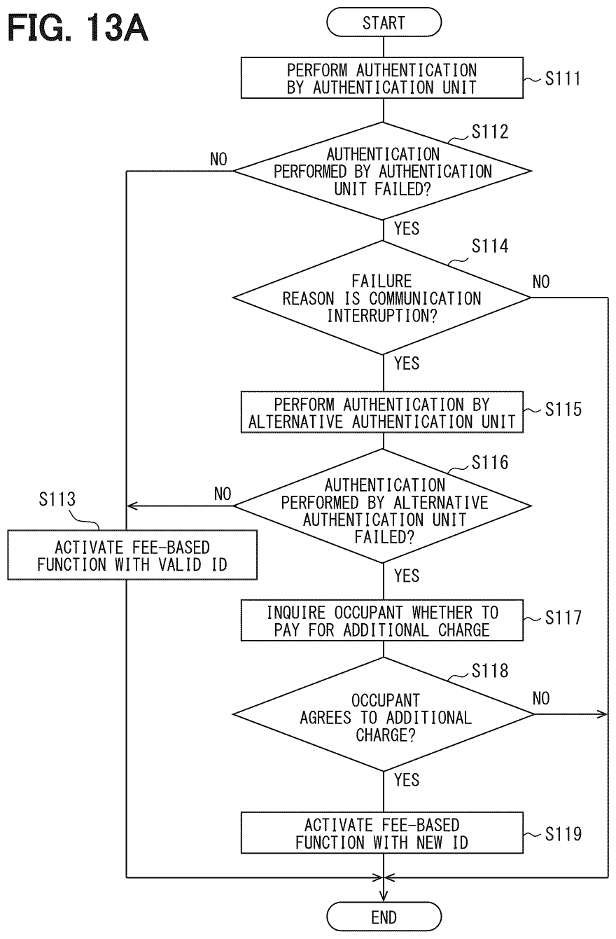

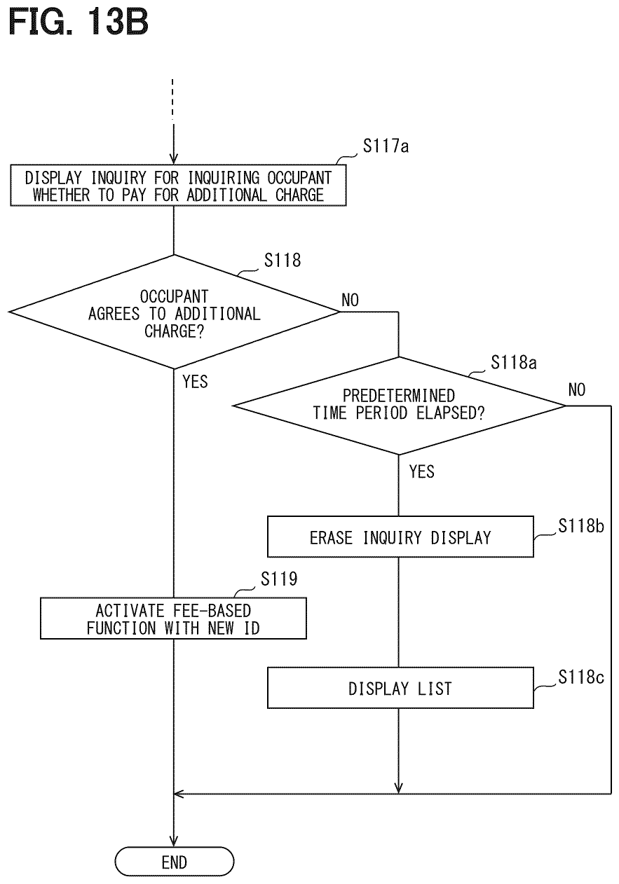

As shown in FIG. 13A, the DCU 4 performs authentication via the network 7 using the authentication unit 4b in S111. In S112, the DCU 4 determines whether the authentication by the authentication unit 4b is successful.

When the authentication is determined to be successful in S112, the DCU 4 activates the fee-based function using the authenticated regular ID (personal authentication identification information) in S113. In this case, the user can use the fee-based function as usual.

When the authentication by the authentication unit 4b fails in S112, the DCU 4 determines in S114 whether the failure is due to a communication interruption caused by a deterioration of communication environment. When the communication has not been interrupted, the DCU 4 determines NO in S114, that is, determines that personal authentication has failed, and exits the process. When the reason for the failure is a communication interruption, the DCU 4 substitutes the authentication performed by the authentication unit 4b with the alternative authentication unit 4c in S115. When the authentication by the alternative authentication unit 4c fails, the DCU 4 inquires of the user in S117 whether to pay for the additional charge for the corresponding fee-based function.

The DCU 4 may make an inquiry from the portable terminal 9 using communication via the short-range wireless communication unit 5. With this configuration, the DCU 4 determines in S118 whether there is an intention to pay for the additional charge. When the DCU 4 receives an input indicating a charging intention from the portable terminal 9, the DCU determines YES in S118 and determines that the user intends to pay for the additional charge for the corresponding fee-based function. In S119, the DCU 4 performs additional charging, for example, by credit card payment, and activates the fee-based function using a new ID (personal authentication information). Thereafter, the corresponding fee-based function may be executed by the HCU 3 or the like. As shown in FIG. 13B, when the user does not indicate an intention for the additional charge and a predetermined time has elapsed in S118a, the DCU 4 may erase the inquiry display P in S118b and display a list of expired fee-based functions in S118c. The same process as that shown in the (First Modification) may be executed.

As described above, according to the present embodiment, when authentication by the authentication unit 4b has failed, the DCU 4 determines whether the occupant intends to pay for the additional charge for the corresponding fee-based function. When the DCU 4 determines that the occupant intends to pay for the additional charge for the corresponding fee-based function, the DCU 4 enables the corresponding fee-based function to be executed. This configuration allows the needs of the occupants to be met and improves user convenience.

### Other Embodiments

The present disclosure is not limited to the embodiments described above, but can be executed by various modifications, and can be applied to various embodiments without departing from the spirit of the present disclosure.

In the above-described embodiments, the DCU 4 mainly executes the authentication process, but some or all of the process and functions may be executed by another in-vehicle instrument (for example, HCU 3). Alternatively, the functions of the HCU 3 can be performed by other in-vehicle instruments (for example, DCU 4).

The method performed by the HCU 3 or the DCU 4 described in the present disclosure may be implemented by a dedicated computer including a memory and a processor programmed to execute one or more functions implemented by a computer program. Alternatively, the method performed by the HCU 3 or the DCU 4 described in the present disclosure may be implemented by a dedicated computer configured by a processor including one or more dedicated hardware logic circuits. Alternatively, the method performed by the HCU 3 or the DCU 4according to the present disclosure may be implemented using one or more dedicated computers including a combination of the processor and the memory programmed to execute one or more functions and the processor with one or more hardware logic circuits. Further, the computer program may be stored, as instructions to be executed by a computer, in a computer-readable non-transitory tangible storage medium.

Processing may be performed by combining the technical ideas of the functions in each embodiment, or by combining the technical ideas of the respective embodiments.

Another aspect of the present disclosure includes the following features.

### Feature (11)

A vehicle authentication system includes: a network communication unit (4a) configured to communicate with a server (8) through a network, the server storing information about a fee-based function that can be executed by an occupant of a vehicle; an authentication unit (4b) configured to authenticate whether the fee-based function can be executed by performing a communication with the server using the network communication unit; and an alternative authentication unit (4c) configured to perform an alternative authentication when the network communication unit fails to connect to the server, wherein the alternative authentication unit performs the alternative authentication when the authentication unit fails to authenticate an execution of the fee-based function due to a connection failure to the server by the network communication unit.

### Feature (12)

The vehicle authentication system according to feature (11), wherein the alternative authentication unit determines that the fee-based function can be executed as an alternative authentication result when the fee-based function is at least one of a function necessary for traveling of the vehicle, a function necessary for safety of the occupant, or a function that improves a comfortability of an internal environment of the vehicle.

### Feature (13)

The vehicle authentication system according to feature (11) or (12), further includes an external environment acquisition unit (6) configured to acquire external environmental information indicating an external environment outside the vehicle, wherein when the alternative authentication unit performs the alternative determination about whether a comfortability function that improves the comfortability of the internal environment of the vehicle can be executed, the alternative authentication unit adds the external environment information of the vehicle to a determination condition of the alternative determination.

### Feature (14)

The vehicle authentication system according to any one of features (11) to (13), wherein, the authentication unit fails to determine whether the fee-based function can be executed while the fee-based function is being executed during a traveling state of the vehicle, the alternative authentication unit determines that the fee-based function can be executed.

### Feature (15)

The vehicle authentication system according to any one of features (11) to (14), further includes a notification control unit (3d) that outputs a notification to the occupant, wherein, when the alternative authentication unit determines whether the fee-based function can be executed by performing the alternative authentication, the notification control unit notifies the occupant of a determination result of the alternative authentication performed by the alternative authentication unit as to whether the fee-based function can be executed or not.

### Feature (16)

The vehicle authentication system according to any one of features (11) to (15), wherein the determination result of the alternative authentication performed by the alternative authentication unit as to whether the fee-based function can be executed maintains valid until the authentication unit becomes possible to perform the authentication or until the vehicle is stopped and a power source of the vehicle is turned off while the authentication by the authentication unit cannot be executed.

### Feature (17)

The vehicle authentication system according to feature (16), further includes a notification control unit (3d) that performs a notification to the occupant, and when (i) the power source of the vehicle is turned off while the authentication by the authentication unit cannot be executed and (ii) the authentication by the authentication unit fails again when the power source of the vehicle is turned on, the notification control unit notifies the occupant that the fee-based function for which the authentication by the authentication unit has failed cannot be used.

### Feature (18)

The vehicle authentication system according to any one of features (11) to (17), further includes an authentication history information storage that stores authentication history information of the fee-based function, and the alternative authentication unit uses the authentication history information of the fee-based function to determine whether to execute the fee-based function.

### Feature (19)

An authentication method for a vehicle includes a step, using a network communication unit (4a), of communicating with a server (8) through a network, the server storing information about a fee-based function that can be executed by an occupant of a vehicle; a step, using an authentication unit (4b), of authenticating whether the fee-based function can be executed by performing a communication with the server using the network communication unit; and a step, using an alternative authentication unit (4c), of performing an alternative authentication when the network communication unit fails to connect to the server, wherein the alternative authentication unit performs the alternative authentication when the authentication unit fails to authenticate an execution of the fee-based function due to a connection failure to the server due to network interruption by the network communication unit.

### Feature (20)

An authentication program for a vehicle includes instructions for performing a step, using a network communication unit (4a), of communicating with a server (8) through a network, the server storing information about a fee-based function that can be executed by an occupant of a vehicle; a step, using an authentication unit (4b), of authenticating whether the fee-based function can be executed by performing a communication with the server using the network communication unit; and a step, using an alternative authentication unit (4c), of performing an alternative authentication when the network communication unit fails to connect to the server, a step, using the alternative authentication unit, of performing the alternative authentication when the authentication unit fails to authenticate an execution of the fee-based function due to a connection failure to the server due to network interruption by the network communication unit.

Another aspect of the present disclosure includes the following features.

### Feature (21)

A vehicle control system includes: a network communication unit (4a) configured to communicate with a server via a network, the server storing information about a fee-based function that can be executed by an occupant of a vehicle; an authentication unit (4b) configured to authenticate whether the fee-based function can be executed by performing a communication with the server using the network communication unit; a search unit (4f) configured to search for an alternative function having same purpose of use as the fee-based function; and a control unit configured to execute the alternative function searched by the search unit when the authentication unit determines that the fee-based function cannot be executed.

### Feature (22)

The vehicle control system according to feature (21), wherein, when the authentication unit determines that the fee-based function cannot be executed due to an interruption of communication connection with the network, the search unit searches for the alternative function that can be executed in an offline state.

### Feature (23)

The vehicle control system according to feature (21) or (22), wherein, when the authentication unit determines that the fee-based function cannot be executed even though the communication connection with the server via the network has been established, the search unit searches for the alternative functions, which can be executed, in the server through the network.

### Feature (24)

The vehicle control system according to any one of features (21) to (23), wherein the search unit searches for the alternative function, which can be executed, in an offline state when the search unit fails to search for the alternative function through the network.

### Feature (25)

The vehicle control system according to any one of features (21) to (24), wherein the authentication unit also determines whether the alternative function can be executed, and the control unit executes the alternative function in response to the authentication unit determining that the alternative function can be executed.

### Feature (26)

The vehicle control system according to any one of features (21) to (25), wherein the search unit searches for the alternative function from functions provided in an external terminal.

### Feature (27)

The vehicle control system according to any one of features (21) to (26), the control unit performs multiple alternative functions to reproduce the fee-based function that is determined to be not executable.

### Feature (28)

The vehicle control system according to any one of features (21) to (27), wherein, when the authentication unit determines that the fee-based function can be executed while the alternative function is being executed, the control unit stops execution of the alternative function and executes the fee-based function with a higher priority than the alternative function.

### Feature (29)

The vehicle control system according to any one of features (21) to (28), wherein, when the alternative function is executed, a priority of alternative function is increased to be higher than the priority of the fee-based function, and the control unit prioritizes execution of the alternative function over the fee-based function.

### Feature (30)

A vehicle control system includes: a network communication unit (4a) configured to communicate with a server via a network, the server storing information about a fee-based function that can be executed by an occupant of a vehicle;
an authentication unit (4b) configured to authenticate whether the fee-based function can be executed by performing a communication with the server using the network communication unit;
an authentication determination unit (4g) configured to determine, in advance, a possibility of at least one of the following situations: an interruption of network connection, or an expiration of the fee-based function, and then determine, in advance, a possibility in which the authentication unit fails to authenticate the fee-based function; and
a notification control unit (3) configured to notify the occupant when the authentication determination unit determines there is the possibility in which the authentication unit fails to authenticate the fee-based function.

### Feature (31)

The vehicle control system according to feature (30), further includes a search unit (4f) configured to search an alternative function having same purpose of use as the fee-based function,
wherein, when the authentication determination unit determines there is the possibility in which the authentication unit fails to authenticate the fee-based function due to the interruption of network connection, the notification control unit proposes to execute the searched alternative function.

### Feature (32)

The vehicle control system according to feature (31), wherein the search unit considers occupant preference as a condition for determining the alternative function.

### Feature (33)

The vehicle control system according to any one of features (30) to (32), further includes a search unit (4f) configured to search an alternative function having same purpose of use as the fee-based function,
wherein, when the authentication determination unit determines that there is the possibility in which the authentication unit fails to authenticate the fee-based function due to an expiration of validity period of the fee-based function, the notification control unit proposes to extend the validity period of the fee-based function to the occupant.

### Feature (34)

A vehicle control method for a vehicle includes: a step, using a network communication unit, of communicating with a server via a network, the server storing information about a fee-based function that can be executed by an occupant of a vehicle; a step, using an authentication unit, of authenticating whether the fee-based function can be executed by performing a communication with the server using the network communication unit; a step, using a search unit, of searching for an alternative function having same purpose of use as the fee-based function; and a step, using a control unit, of executing the alternative function searched by the search unit when the authentication unit determines that the fee-based function cannot be executed.

### Feature (35)

A vehicle control program including instructions for performing a step, using a network communication unit, of communicating with a server via a network, the server storing information about a fee-based function that can be executed by an occupant of a vehicle; a step, using an authentication unit, of authenticating whether the fee-based function can be executed by performing a communication with the server using the network communication unit; a step, using a search unit, of searching for an alternative function having same purpose of use as the fee-based function; and a step, using a control unit, of executing the alternative function searched by the search unit when the authentication unit determines that the fee-based function cannot be executed.

Another aspect of the present disclosure includes the following features.

### Feature (41)

A vehicle control system includes: a network communication unit (4a) configured to communicate with a server (8) via a network, the server storing information about a fee-based function that can be executed by an occupant of a vehicle; an authentication unit (4b) configured to authenticate whether the fee-based function can be executed by performing a communication with the server using the network communication unit; and a control unit (3) configured to enable an execution of the fee-based function, wherein, when the authentication performed by the authentication unit fails, the authentication unit determines whether the occupant intends to pay for an additional charge for the fee-based function, and the control unit enables execution of the fee-based function in response to the authentication unit determining that the occupant intends to pay for the additional charge for the fee-based function.

### Feature (42)

The vehicle control system according to feature (41), wherein, when the authentication unit determines that the occupant intends to pay for the additional charge and the control unit enables the execution of the fee-based function, the control unit performs an online authentication via the network communication unit, confirms the information stored in the server, in response to determining that the fee-based function is available without additional charge, the control unit cancels the additional charge required for the fee-based function and executes the fee-based function.

### (Feature 43)

The vehicle control system according to feature (41) or (42), further includes an operation input device configured to receive an approval operation input by the occupant, and the approval operation indicates an occupant intention to pay for the additional charge.

### Feature (44)

The vehicle control system according to any one of features (41) to (43), further includes a notification control unit configured to display an inquiry that inquires the occupant whether to pay for the additional charge, wherein the notification control unit erases display of the inquiry that inquires the occupant whether to pay for the additional charge when the operation input device fails to receive the approval operation for a predetermined period of time.

### Feature (45)

The vehicle control system according to any one of features (41) to (44), wherein the notification control unit displays, via a pop-up display, a list of functions for which the operation input device fails to receive the approval operation or a list of expired fee-based functions.

### Feature (46)

A vehicle control system includes: a network communication unit (4a) configured to communicate with a server (8) via a network, the server storing information about a fee-based function that can be executed by an occupant of a vehicle; an authentication unit (4b) configured to authenticate whether the fee-based function can be executed by performing a communication with the server using the network communication unit; and a control unit (3) configured to enable an execution of the fee-based function; and an alternative authentication unit (4d) configured to perform an alternative authentication when the authentication unit fails to authenticate the fee-based function; wherein, when the alternative authentication performed by the alternative authentication unit fails, the control unit determines whether the occupant intends to pay for an additional charge for the fee-based function, and the control unit enables execution of the fee-based function in response to determining that the occupant intends to pay for the additional charge for the fee-based function.

### Feature (47)

A vehicle control method comprising: a step, using a network communication unit, of communicating with a server via a network, the server storing information about a fee-based function that can be executed by an occupant of a vehicle; a step, using an authentication unit, of authenticating whether the fee-based function can be executed by performing a communication with the server using the network communication unit; and a step, using a control unit, of executing the fee-based function, wherein, when the authentication performed by the authentication unit fails, the authentication unit determines whether the occupant intends to pay for an additional charge for the fee-based function, and the control unit enables execution of the fee-based function in response to determining that the occupant intends to pay for the additional charge for the fee-based function.

### Feature (48)

A vehicle control program including instructions for performing a step, using a network communication unit, of communicating with a server via a network, the server storing information about a fee-based function that can be executed by an occupant of a vehicle; a step, using an authentication unit, of authenticating whether the fee-based function can be executed by performing a communication with the server using the network communication unit; and a step, using a control unit, of executing the fee-based function, wherein, when the authentication performed by the authentication unit fails, the authentication unit determines whether the occupant intends to pay for an additional charge for the fee-based function, and the control unit enables execution of the fee-based function in response to determining that the occupant intends to pay for the additional charge for the fee-based function.

The present disclosure has been described in accordance with the embodiments. However, it is to be understood that the present disclosure is not limited to the embodiments and configurations described above. The present disclosure includes various modification examples and equivalents thereof. In addition, various combinations and configurations, as well as other combinations and configurations that include only one element, more, or less, are within the scope and spirit of the present disclosure.

What is claimed is:

1. A vehicle control system equipped to a vehicle, the vehicle control system comprising at least one of (i) a circuit and (ii) a processor with a memory storing computer program code executable by the processor, the at least one of the circuit and the processor configured to cause the vehicle control system to:
communicate with a server via a network, the server storing information about a fee-based function that can be executed by an occupant of the vehicle;
authenticate whether the fee-based function can be executed by performing a communication with the server;
in response to an authentication of the fee-based function being succeeded, enable an execution of the fee-based function;
in response to the authentication of the fee-based function being failed, determine whether the occupant intends to pay for an additional charge for the fee-based function without using (i) information transmitted from the server in advance or (ii) information generated with a same method as a generation method of information in the server; and
in response to determining that the occupant intends to pay for the additional charge for the fee-based function, enable the execution of the fee-based function.

2. A vehicle control system equipped to a vehicle, the vehicle control system comprising at least one of (i) a circuit and (ii) a processor with a memory storing computer program code executable by the processor, the at least one of the circuit and the processor configured to cause the vehicle control system to:
communicate with a server via a network, the server storing information about a fee-based function that can be executed by an occupant of the vehicle;
authenticate whether the fee-based function can be executed by performing a communication with the server;
in response to an authentication of the fee-based function being succeeded, enable an execution of the fee-based function;
in response to the authentication of the fee-based function being failed, determine whether the occupant intends to pay for an additional charge for the fee-based function; and
in response to determining that the occupant intends to pay for the additional charge for the fee-based function, enable the execution of the fee-based function,
wherein,
during the execution of the fee-based function in response to determining that the occupant intends to pay for the additional charge for the fee-based function, the at least one of the circuit and the processor is further configured to perform an online authentication by communicating with the server via the network and check information stored in the server, and
in response to determining that the fee-based function is available without paying for the additional charge, the at least one of the circuit and the processor is configured to execute the fee-based function and cancel the additional charge paid for the fee-based function.

3. The vehicle control system according to claim 1, further comprising
an operation input device configured to receive, from the occupant, an approval operation indicating that the occupant intends to pay for the additional charge for the fee-based function.

4. The vehicle control system according to claim 3, wherein the at least one of the circuit and the processor is further configured to:
display an inquiry to the occupant for inquiring whether the occupant intends to pay for the additional charge; and
delete the inquiry, which inquires whether the occupant intends to pay for the additional charge, in response to the operation input device fails to receive the approval operation from the occupant for a predetermined period of time.

5. The vehicle control system according to claim 4, wherein the at least one of the circuit and the processor is further configured to
display, in a pop-up window, a list of fee-based functions for which the operation input device fails to receive approval operations or a list of expired fee-based functions.

6. A vehicle control system equipped to a vehicle, the vehicle control system comprising at least one of (i) a circuit and (ii) a processor with a memory storing computer program code executable by the processor, the at least one of the circuit and the processor configured to cause the vehicle control system to:
communicate with a server via a network, the server storing information about a fee-based function that can be executed by an occupant of the vehicle;
authenticate whether the fee-based function can be executed by preforming a communication with the server;
in response to an authentication of the fee-based function being succeeded, enable an execution of the fee-based function;
in response to an authentication of the fee-based function being failed, perform an alternative authentication;
in response to the alternative authentication of the fee-based function being failed, determine whether the occupant intends to pay for an additional charge for the fee-based function without using (i) information transmitted from the server in advance or (ii) information generated with a same method as a generation method of information in the server; and
in response to determining that the occupant intends to pay for the additional charge for the fee-based function, enable the execution of the fee-based function.

7. A vehicle control method executed in a vehicle, the vehicle control method comprising:
communicating with a server via a network, the server storing information about a fee-based function that can be executed by an occupant of the vehicle;
authenticating whether the fee-based function can be executed by performing a communication with the server;
in response to an authentication of the fee-based function being succeeded, enabling an execution of the fee-based function;
in response to the authentication of the fee-based function being failed, determining whether the occupant intends to pay for an additional charge for the fee-based function without using (i) information transmitted from the server in advance or (ii) information generated with a same method as a generation method of information in the server; and
in response to determining that the occupant intends to pay for the additional charge for the fee-based function, enabling the execution of the fee-based function.

8. A computer-readable non-transitory storage medium storing a vehicle control program, the vehicle control program comprising instructions to be executed by at least one processor of a vehicle control system equipped to a vehicle, the instructions comprising:
communicating with a server via a network, the server storing information about a fee-based function that can be executed by an occupant of the vehicle;
authenticating whether the fee-based function can be executed by performing a communication with the server;
in response to an authentication of the fee-based function being succeeded, enabling an execution of the fee-based function;
in response to the authentication of the fee-based function being failed, determining whether the occupant intends to pay for an additional charge for the fee-based function without using (i) information transmitted from the server in advance or (ii) information generated with a same method as a generation method of information in the server; and
in response to determining that the occupant intends to pay for the additional charge for the fee-based function, enabling the execution of the fee-based function.

9. A vehicle control method executed in a vehicle, the vehicle control method comprising:
communicating with a server via a network, the server storing information about a fee-based function that can be executed by an occupant of the vehicle;
authenticating whether the fee-based function can be executed by performing a communication with the server;
in response to an authentication of the fee-based function being succeeded, enabling an execution of the fee-based function;
in response to the authentication of the fee-based function being failed, determining whether the occupant intends to pay for an additional charge for the fee-based function;
in response to determining that the occupant intends to pay for the additional charge for the fee-based function, enabling the execution of the fee-based function;
during the execution of the fee-based function in response to determining that the occupant intends to pay for the additional charge for the fee-based function, performing an online authentication by communicating with the server via the network and check information stored in the server; and
in response to determining that the fee-based function is available without paying for the additional charge, executing the fee-based function and cancel the additional charge paid for the fee-based function.

10. A computer-readable non-transitory storage medium storing a vehicle control program, the vehicle control program comprising instructions to be executed by at least one processor of a vehicle control system equipped to a vehicle, the instructions comprising:
communicating with a server via a network, the server storing information about a fee-based function that can be executed by an occupant of the vehicle;
authenticating whether the fee-based function can be executed by performing a communication with the server;
in response to an authentication of the fee-based function being succeeded, enabling an execution of the fee-based function;
in response to the authentication of the fee-based function being failed, determining whether the occupant intends to pay for an additional charge for the fee-based function;
in response to determining that the occupant intends to pay for the additional charge for the fee-based function, enabling the execution of the fee-based function;
during the execution of the fee-based function in response to determining that the occupant intends to pay for the additional charge for the fee-based function, performing an online authentication by communicating with the server via the network and check information stored in the server; and
in response to determining that the fee-based function is available without paying for the additional charge, executing the fee-based function and cancel the additional charge paid for the fee-based function.
